(19) United States
(12) Patent Application Publication
(10) Pub. No.: US 2016/0089567 A1
(43) Pub. Date: Mar. 31, 2016

(54) FORM ANALYZING DEVICE, FORM ANALYZING SYSTEM, FORM ANALYZING METHOD, AND FORM ANALYZING PROGRAM

(71) Applicant: SEIKO EPSON CORPORATION, Tokyo (JP)

(72) Inventor: Koichi HATANAKA, Matsumoto-shi (JP)

(21) Appl. No.: 14/847,832

(22) Filed: Sep. 8, 2015

(30) Foreign Application Priority Data
Sep. 26, 2014 (JP) 2014-196235
Nov. 11, 2014 (JP) 2014-228652
Nov. 28, 2014 (JP) 2014-241010

(51) Int. Cl. A63B 24/00; A63B 69/36; A63B 71/06; G09B 19/00

(52) U.S. Cl. CPC A63B 24/0006; G09B 19/0038; A63B 69/3608; A63B 71/0622; A63B 71/0669; A63B 69/36; A63B 2024/0009; A63B 2071/0647

(57) ABSTRACT

A form analyzing device includes a storing section configured to store form information in the past in which detection results in the past of an inertia sensor (an inertia measuring unit) attached to the upper limb of a user or a hitting instrument held by the hand of the user and forms of swings of the user are associated, an estimating section configured to extract, from the storing section, the form information in the past corresponding to the present detection result of the inertia sensor, and a notifying section configured to notify the user of the present form information based on the form information in the past corresponding to the present detection result.

The entire disclosure of Japanese Patent Application No. 2014-196235, filed Sep. 26, 2014, Japanese Patent Application No. 2014-228652, filed Nov. 11, 2014, and Japanese Patent Application No. 2014-241010, filed Nov. 28, 2014, are hereby expressly incorporated by reference herein.

### BACKGROUND

1. Technical Field

The present invention relates to a form analyzing device, a form analyzing system, and a form analyzing method for analyzing a form of a swing such as a golf swing and a form analyzing program for executing the form analyzing method.

2. Related Art

There has been proposed various support devices for supporting golf plays. For example, JP-A-2005-270508 (Patent Literature 1) introduces, as a form analyzing system for analyzing a form of a golf swing, a form analyzing system that causes a player to wear clothes for measurement created in order to dispose markers in parts of a body, photographs a swing of the player with a camera, compares data of a form of the swing quantified from position coordinates of the markers of a photographed image and ideal value data input to a computer in advance, and diagnoses the form.

As another support device for golf plays, there is known a device that measures the number of times of hitting by a golf club functioning as a hitting instrument and automatically counts, for example, the number of strokes of a player in a round. For example, JP-A-2002-017932 (Patent Literature 2) introduces a number-of-strokes counting device that detects an impact of collision of a hitting surface (face) of a putter functioning as a hitting instrument and a ball, counts the number of times of the detected impact and stores the number of times as number-of-times data, and outputs the stored number-of-times data.

Patent Literature 2 introduces a counting system for the number of strokes that detects collision (impact) of a hitting surface (a club face) of a golf club (a putter) functioning as a hitting instrument and a ball, counts the number of times of the detected collision and stores the number of times as number-of-times data, and outputs the stored number-of-times data.

However, in the form analyzing system described in Patent Literature 1, the player needs to wear clothes exclusive for measurement and a large system configuration including a camera and an image processing device is necessary. Therefore, it is difficult to use the form analyzing system in a golf course and perform a form analysis during an actual round.

The number-of-strokes counting device described in Patent Literature 2 is exclusive for putting. However, hitting of golf is not limited to the putting. The impact of hitting in a shot of golf is stronger than the impact of the putting. However, Patent Literature 2 does not take into account this point. Therefore, when the number-of-strokes counting device of Patent Literature 2 is used for a round of golf including the shot and the putting, it is likely that misdetection occurs because of a large difference in the strength of the impact and the impact of the shot or the putting cannot be detected. As a result, the number of strokes cannot be accurately counted.

In the counting system described in Patent Literature 2, it is likely that, even when an object other than the ball hits the club face, the hitting is counted as the number of strokes. Even when the player hits the ball again in the case of OB (Out of Bounds), that is, when the player hits the ball to the outside of a play area, only the number of times of collision of the club face and the ball is counted without adding one penalty stroke according to a counting method for the number of strokes in the case of the OB. Therefore, it is likely that a correct number of strokes cannot be counted.

### SUMMARY

An advantage of some aspects of the invention is to provide a form analyzing device, a form analyzing system, and a form analyzing method that can analyze a form of a swing or the like of a user and notify the user of form information, which is an analysis result, without requiring a large system configuration and a form analyzing program for causing the form analyzing device and the form analyzing system to execute the form analyzing method.

Another advantage of some aspects of the invention is to provide a putting detecting device and a putting detecting system that can reduce, when performing swing detection for detecting a physical quantity of a swing by a hitting instrument on the basis of a determination criterion, an error of the swing detection that could occur because a difference between impacts of hitting of a shot and putting is relatively large and a computer program for causing the putting detecting device and the putting detecting system to execute putting detection.

Still another advantage of some aspects of the invention is to solve a problem of a miscount that occurs because a swing or an impact, which should not originally be counted as the number of strokes, are detected and included in the number of strokes, and to provide a counting system and a counting method for counting the number of strokes with fewer miscounts on the basis of a detection result of detection by a sensor and the position of a hitting instrument or a player at time corresponding to the detection result and a computer program for causing the counting system to execute a counting method.

### APPLICATION EXAMPLE 1

A form analyzing device according to this application example includes: a storing section configured to store form information in the past in which detection results in the past of a physical quantity sensor attached to the upper limb of a user or a hitting instrument held by the hand of the user and forms of swings of the user are associated; an estimating section configured to extract, from the storing section, the form information in the past corresponding to the present detection result of the physical quantity sensor; and a notifying section configured to notify the user of the present form information based on the form information in the past corresponding to the present detection result.

According to this application example, a plurality of kinds of form information in the past in which detection results in the past of the physical quantity sensor attached to the upper limb of the user or the hitting instrument held by the hand of the user and the forms of the swings of the user are associated are stored in the storing section in advance. The form information in the past corresponding to the present detection result of the physical quantity sensor is extracted out of the plurality of kinds of form information in the past. The present form information based on the form information in the past is notified to the user. Consequently, it is possible to provide the form analyzing device that performs a swing analysis of the user and notifies the user of the present form information, which is a result of the analysis, on a real-time basis with a simple configuration in which the physical quantity sensor is attached to the upper limb or the hitting instrument compared with a large-scale swing analyzing device in the past including, for example, a plurality of sensors attached to parts of a body, an image pickup device, and an image processing device.

### APPLICATION EXAMPLE 2

In the form analyzing device according to the application example, the form analyzing device may further include the physical quantity sensor.

According to this application example, it is possible to provide the form analyzing device in which the physical quantity sensors and other device portions are integrally configured.

### APPLICATION EXAMPLE 3

The form analyzing device according to the application example may further include a communication section configured to communicate with the physical quantity sensor.

According to this application example, the physical quantity sensor and the other device portions are separated. The physical quantity sensor and the other device portions communicate through the communication section. Consequently, it is possible to attain a reduction in the size of the physical quantity sensor attached to the user or the hitting instrument. It is possible to increase a degree of freedom of design of the shapes of the device portions, attachment forms, and the like.

### APPLICATION EXAMPLE 4

In the form analyzing device according to the application example, the present form information may include an advice for improving a form.

According to this application example, the user can attain improvement of a form of a swing with reference to an advice based on a form analysis result while performing a swinging play.

### APPLICATION EXAMPLE 5

In the form analyzing device according to the application example, the present form information may include images of the forms.

According to this application example, for example, it is possible to dispose an image display section in the form analyzing device and notify the user, with an image displayed on the image display section, at least a part of the present form information obtained by the form analysis. Therefore, there is an effect that it is possible to obtain visually clear swing analysis information.

### APPLICATION EXAMPLE 6

A form analyzing system according to this application example includes: a physical quantity sensor attached to the upper limb of a user or a hitting instrument held by the hand of the user; and a form analyzing device including: a communication section configured to communicate with the physical quantity sensor; a storing section configured to store form information in the past in which detection results in the past of a physical quantity sensor and forms of swings of the user are associated; an estimating section configured to extract, from the storing section, the form information in the past corresponding to the present detection result of the physical quantity sensor; and a notifying section configured to notify the user of the present form information based on the form information in the past corresponding to the present detection result.

According to this application example, a plurality of kinds of form information in the past in which detection results in the past of the physical quantity sensor attached to the upper limb of the user or the hitting instrument held by the hand of the user and the forms of the swings of the user are associated are stored in the storing section in advance. The form information in the past corresponding to the present detection result of the physical quantity sensor is extracted out of the plurality of kinds of form information in the past. The present form information based on the form information in the past is notified to the user. Consequently, it is possible to provide the form analyzing system that performs a swing analysis of the user and notifies the user of the present form information, which is a result of the analysis, on a real-time basis with a simple configuration in which the physical quantity sensor is attached to the upper limb or the hitting instrument.

### APPLICATION EXAMPLE 7

A form analyzing method according to this application example includes: storing, in a storing section, form information in the past in which detection results in the past of a physical quantity sensor attached to the upper limb of a user or a hitting instrument held by the hand of the user and forms of swings of the user are associated; extracting, from the storing section, the form information in the past corresponding to the present detection result of the physical quantity sensor; and notifying the user of the present form information based on the form information in the past corresponding to the present detection result.

According to this application example, it is possible to store, in advance, a plurality of kinds of form information in the past in which detection results in the past of the physical quantity sensor attached to the upper limb of the user or the hitting instrument held by the hand of the user and the forms of the swings of the user are associated, extract the form information in the past corresponding to the present detection result of the physical quantity sensor out of the plurality of kinds of form information in the past, and notify the user of the present form information based on the form information in the past. Consequently, it is possible to provide the form analyzing method for performing a swing analysis of the user and notifying the user of the present form information, which is a result of the analysis, on a real-time basis with a simple configuration in which the physical quantity sensor is attached to the upper limb or the hitting instrument compared with a swing analyzing method by a large-scale system configuration in the past including, for example, a plurality of sensors attached to parts of a body, an image pickup device, and an image processing device.

### APPLICATION EXAMPLE 8

In the form analyzing method according to the application example, the present form information may include an advice for improving a form.

According to this application example, the user can attain improvement of a form of the present swing on the basis of the form information in the past while performing a swinging play such as golf.

### APPLICATION EXAMPLE 9

In the form analyzing method according to the application example, the present form information may include images of the forms.

According to this application example, at least a part of the present form information is notified to the user by an image. Therefore, there is an effect that the present form information is visual and clear.

### APPLICATION EXAMPLE 10

A form analyzing program according to this application example causes a form analyzing system to execute a form analyzing method including: storing, in a storing section, form information in the past in which detection results in the past of a physical quantity sensor attached to the upper limb of a user or a hitting instrument held by the hand of the user and forms of swings of the user are associated; extracting, from the storing section, the form information in the past corresponding to the present detection result of the physical quantity sensor; and notifying the user of the present form information based on the form information in the past corresponding to the present detection result.

According to this application example, it is possible to cause the form analyzing system to execute the form analyzing method for storing, in advance, a plurality of kinds of form information in the past in which detection results in the past of the physical quantity sensor attached to the upper limb of the user or the hitting instrument held by the hand of the user and the forms of the swings of the user are associated, extracting the form information in the past corresponding to the present detection result of the physical quantity sensor out of the plurality of kinds of form information in the past, and notifying the user of the present form information based on the form information in the past. Consequently, it is possible to execute the form analyzing method for performing a swing analysis of the user and notifying the user of the present form information, which is a result of the analysis, on a real-time basis with a simple configuration in which the physical quantity sensor is attached to the upper limb or the hitting instrument compared with a swing analyzing method by a large-scale system configuration in the past including, for example, a plurality of sensors attached to parts of a body, an image pickup device, and an image processing device.

### APPLICATION EXAMPLE 11

A putting detecting device according to this application example includes a swing detecting section configured to detect a physical quantity related to a swing of a hitting instrument on the basis of a determination criterion. The swing detecting section has a putting mode in which the determination criterion is a determination criterion for putting and a shot mode in which the determination criterion is a determination criterion for shot different from the putting. The swing detecting section includes a switching unit configured to switch the determination criterion to the determination criterion for putting when a swing by the hitting instrument is the putting.

According to the application example, when a swing by the hitting instrument is the putting, the determination criterion for the swing detection is switched from the shot mode in which the determination criterion is the determination criterion for a shot to the putting mode in which the determination criterion is the determination criterion for putting. Consequently, it is possible to accurately perform swing detection of the putting according to the determination criterion for swing detection (the putting mode) suitable for the putting.

### APPLICATION EXAMPLE 12

In the putting detecting device according to the application example, the switching unit may be an operation section operated by a player.

According to this application example, the player himself or herself detecting that a swing to be performed is the putting can switch the determination criterion to the putting mode by operating the operation section.

### APPLICATION EXAMPLE 13

In the putting detecting device according to the application example, the switching unit may switch the determination criterion to the putting mode when a predetermined member attached to an attachment section is detached.

According to this application example, by applying, as the predetermined member, a member detached from the attachment section when the swing is switched to the putting, it is possible to detect that the swing is switched from the shot to the putting by operation for detaching the member from the attachment section and automatically surely perform the switching of the determination criterion from the shot mode to the putting mode.

### APPLICATION EXAMPLE 14

In the putting detecting device according to the application example, the switching unit may be communication with the predetermined member.

According to this application example, it is possible to configure, in a variety of variations, the putting detecting device that detects the putting and switches the determination criterion to the putting mode through communication with the operation section or a predetermined member capable of detecting that the swing is switched to the putting.

### APPLICATION EXAMPLE 15

In the putting detecting device according to the application example, the predetermined member may be a ball marker or a golf ball.

According to the application example, according to, for example, detachment of members from the attachment section, it is possible to detect that the swing is switched to the putting and switch the determination criterion of the switching detecting section to the putting mode.

For example, the ball marker is always placed on a green in order to mark the position of a ball by immediately before the putting. Therefore, it is possible to detect that the swing is the putting when the player carries the ball marker in a state in which the ball marker is attached to the attachment section and detaches the ball marker from the attachment section in placing the ball marker on the green.

Only in the case of a practice round in which a play can be performed by informing that, after the position of the ball on the green is marked by the ball marker at the time of the putting, the ball is switched to a ball exclusive for putting, it is possible to detect that the swing is the putting when the player stores and carries the ball exclusive for putting in a ball case or the like functioning as the attachment section and takes out the ball exclusive for putting from the ball case in order to place the ball on the green when performing the putting.

### APPLICATION EXAMPLE 16

In the putting detecting device according to the application example, the switching unit may be an image pickup section including an image pickup device.

According to this application example, it is possible to detect the putting when images of objects and places used for the putting performed on the green or characteristic states of the objects and the places are picked up by the image pickup device and switch the determination criterion of the swing detecting section to the putting mode.

### APPLICATION EXAMPLE 17

A putting detecting system according to this application example includes a swing detecting section configured to detect a physical quantity related to a swing of a hitting instrument on the basis of the determination criterion. The swing detecting section includes a first detecting device having a putting mode in which the determination criterion is a determination criterion for putting and a shot mode in which the determination criterion is a determination criterion for a shot different from the putting and a second detecting device configured to detect whether the swing by the hitting instrument is the putting. When the second detecting device detects that the swing by the hitting instrument is the putting, the switching detecting section switches the determination criterion of the first detecting device to the putting mode.

According to this application example, the swing detecting section includes the second detecting device configured to detect whether the swing by the hitting instrument is the putting. When the second detecting device determines that the swing by the hitting instrument is the putting, the swing detecting section switches the determination criterion for swing detection by the first detecting device from the shot mode to the putting mode. Consequently, it is possible to accurately perform the swing detection of the putting according to the determination criterion for the swing detection (the putting mode) suitable for the putting. Even when swing detection of a shot different from the putting is performed, it is possible to accurately perform the swing detection of the shot according to the determination criterion for swing detection (the shot mode) suitable for the shot.

### APPLICATION EXAMPLE 18

In the putting detecting system according to the application example, the second detecting device may include an attachment section and a predetermined member attachable to the attachment section. The second detecting device may detect that the swing is the putting when the predetermined member is detached from the attachment section.

According to this application example, by applying, as the predetermined member, a member detached from the attachment section when the swing is switched to the putting, it is possible to detect that the swing is switched from the shot to the putting by operation for detaching the member from the attachment section and automatically surely perform the switching to the putting mode.

### APPLICATION EXAMPLE 19

In the putting detecting system according to the application example, the predetermined member may be any one of a ball marker, a flagpole, and a ball.

According to the application example, it is possible to configure, in a variety of variations, the putting detecting system that detects the putting, with which the determination criterion can be switched to the putting mode, and switches the determination criterion to the putting mode through communication with the operation section or a predetermined member capable of detecting that the swing is switched to the putting.

### APPLICATION EXAMPLE 20

In the putting detecting system according to the application example, the second detecting device may include an image pickup section including the image pickup device.

According to this application example, it is possible to detect the putting when images of objects and places used for the putting performed on the green or characteristic states of the objects and the places are picked up by the image pickup device and switch the determination criterion of the swing detecting section to the putting mode.

### APPLICATION EXAMPLE 21

In the putting detecting system according to this application example, the second detecting device may detect that the swing is the putting when the image pickup section detects that the hitting instrument is a putter, a ball marker or a ball is present on a green, a cup is present, or a state is different from a state in which a flagpole is erected in a hole.

According to this application example, all of the objects and the places are objects and places always used by immediately before the putting or objects and places that change in states, for example, are detached at the time of the putting. Therefore, according to image pickup of the objects or the places or the change in the state by the image pickup device, it is possible to detect the putting and switch the determination criterion of the switching detecting section to the putting mode.

### APPLICATION EXAMPLE 22

In the putting detecting system according to the application example, the second detecting device may include a communicating unit configured to communicate with the first detecting device.

According to this application example, it is possible to configure, in a variety of variations, the putting detecting system that detects the putting and switches the determination criterion to the putting mode through communication with the operation section or a predetermined member capable of detecting that the swing is switched to the putting.

### APPLICATION EXAMPLE 23

In the putting detecting system according to the application example, the second detecting device may be included in any one of a putter, a ball marker, a ball, and a cup.

According to this application example, all of the putter, the ball marker, the ball (a ball exclusive for putting), and the cup are objects and places used for the putting performed on a green. Therefore, by detecting locations and states of the putter, the ball marker, the ball, and the cup or performing communication with the putter, the ball marker, the ball, and the cup, it is possible to detect that the swing is switched to the putting and switch the determination criterion of the swing detecting section to the putting mode.

### APPLICATION EXAMPLE 24

A computer program according to this application example causes the putting detecting system according to the application example to execute putting detection.

According to this application example, with the putting detecting system according to the application example, it is possible to surely detect that the swing is switched to the putting, switch the determination criterion of the swing detecting section to the putting mode suitable for the putting, and accurately perform swing detection of the putting.

### APPLICATION EXAMPLE 25

A counting method according to this application example includes: counting, on the basis of a detection result of a physical quantity detected by a sensor attached to a hitting instrument, the number of strokes by the hitting instrument; calculating, with a positioning device, a position of a hitting instrument or a player, who performs hitting by the hitting instrument, at time corresponding to the detection result; and adjusting the number of strokes when the position at time corresponding to a detection result of the last time and the position at time corresponding to a detection result of this time are included within a given condition range.

According to this application example, the number of strokes is counted on the basis of the detection result of the sensor attached to the hitting instrument. The position of the hitting instrument or the player at the time corresponding to the detection result is acquired by the positioning device. The number of strokes is adjusted according to a relation between the position at the time corresponding to the detection result of the last time and the position corresponding to the detection result of this time. Consequently, for example, when the position of the detection result of the last time and the position of the detection result of this time are measured as the same position, it is possible to determine the hitting of the detection result of this time as “hitting performed again”. It is possible to delete the number of strokes counted on the basis of the detection result of the last time and count the number of strokes or add a penalty stroke and count the number of strokes to adjust the number of strokes. Therefore, on the basis of the detection result of the detection by the sensor and the position of the hitting instrument or the player at time corresponding to the detection result, it is possible to provide the counting method capable of performing more accurate counting than when the position is not taken into account.

### APPLICATION EXAMPLE 26

In the counting method according to the application example, the counting includes counting the number of strokes on the basis of movement of the hitting instrument estimated from the detection result.

According to this application example, it is possible to count the number of strokes on the basis of the movement of the hitting instrument. Therefore, it is possible to improve reliability of the counting of the number of strokes.

### APPLICATION EXAMPLE 27

In the counting method according to the application example, the counting includes counting the number of strokes on the basis of an impact of hitting by the hitting instrument or time in which the hitting instrument is held.

According to this application example, by counting the number of strokes on the basis of the impact of the hitting by the hitting instrument or the time in which the hitting instrument is held, it is possible to exclude a swing not being a target of counting such as a practice swing and perform more accurate counting of the number of strokes.

### APPLICATION EXAMPLE 28

A counting system according to this application example includes: a sensor attached to a hitting instrument and configured to output a detection result of detection of a physical quantity of the hitting instrument; a positioning device configured to measure a position of a hitting instrument or a player who performs hitting by the hitting instrument at time corresponding to the detection result; and a number-of-strokes calculating device including: a counting section configured to count the number of strokes by the hitting instrument on the basis of the detection result; and a number-of-strokes adjusting section configured to adjust the number of strokes when the position at time corresponding to a detection result of the last time and the position at time corresponding to a detection result of this time are within a given condition range.

According to this application example, the counting system includes the counting section configured to count the number of strokes on the basis of the detection result of the sensor attached to the hitting instrument, the positioning device configured to acquire the position of the hitting instrument or the player at the time corresponding to the detection result, and the number-of-strokes adjusting section configured to adjust the number of strokes according to a relation between the position at the time corresponding to the detection result of the last time and the position corresponding to the detection result of this time. Consequently, for example, when the position of the detection result of the last time and the position of the detection result of this time are measured as the same position, it is possible to determine the hitting of the detection result of this time as “hitting performed again”. It is possible to delete the number of strokes counted on the basis of the detection result of the last time and count the number of strokes or add a penalty stroke and count the number of strokes to adjust the number of strokes.

Therefore, on the basis of the detection result of the detection by the sensor and the position of the hitting instrument or the player at time corresponding to the detection result, it is possible to provide the counting system capable of performing more accurate counting than when the position is not taken into account.

### APPLICATION EXAMPLE 29

In the counting system according to the application example, the counting section may count the number of strokes on the basis of movement of the hitting instrument estimated from the detection result.

According to this application example, by detecting the movement of the hitting instrument, it is possible to detect a type of a swing and time in which the hitting instrument is held. Therefore, it is possible to grasp, in detail, the movement of the hitting instrument in the hitting of the player and improve reliability of a count value of the number of strokes.

### APPLICATION EXAMPLE 30

In the counting system according to the application example, the counting section may count the number of strokes on the basis of an impact of hitting by the hitting instrument or time in which the hitting instrument is held.

According to the application example, on the basis of the impact of the hitting by the hitting instrument or the time in which the hitting instrument is held, it is possible to exclude a swing not being a target of counting such as a practice swing and perform counting of the number of strokes with fewer miscounts.

### APPLICATION EXAMPLE 31

The counting system according to the application example may further include a display device configured to display the counting result.

According to this application example, a player can check the counting result of the number of strokes by the counting system.

### APPLICATION EXAMPLE 32

In the counting system according to the application example, the display device may include an input section for inputting an adjustment value of the number-of-strokes adjusting section.

According to this application example, in the counting system that adjusts, in the counting of the number of strokes based on the detection result of the detection by the sensor and the acquisition of the position of the hitting instrument or the player at the time corresponding to the detection result of the sensor, the number of strokes according to a relation between the position at the time corresponding to the detection result of the last time and the position corresponding to the detection result of this time, when an unexpected situation occurs in the positional relation, it is possible to manually input the adjustment value.

Therefore, it is possible to provide a counting system capable of obtaining a counting result with fewer miscounts even when the unexpected situation occurs.

### APPLICATION EXAMPLE 33

A computer program according to this application example includes: counting, on the basis of a detection result of a physical quantity detected by a sensor attached to a hitting instrument, the number of strokes by the hitting instrument; calculating, with a positioning device, a position of the hitting instrument or a player who performs hitting by the hitting instrument at time corresponding to the detection result; and adjusting the number of strokes when the position at time corresponding to a detection result of the last time and the position at time corresponding to a detection result of this time are included within a given condition range, the computer program causing a counting system to execute counting of the number of strokes by the hitting instrument.

According to this application example, the number of strokes is counted on the basis of the detection result of the sensor attached to the hitting instrument. The position of the hitting instrument or the player at time corresponding to the detection result is acquired by the positioning device. The number of strokes is adjusted according to a relation between the position at the time corresponding to the detection result of the last time and the position corresponding to the detection result of this time. Consequently, for example, when the position of the detection result of the last time and the position of the detection result of this time are measured as the same position, it is possible to determine the hitting of the detection result of this time as “hitting performed again”. It is possible to delete the number of strokes counted on the basis of the detection result of the last time and count the number of strokes or add a penalty stroke and count the number of strokes to adjust the number of strokes.

Therefore, on the basis of the detection result of the detection by the sensor and the position of the hitting instrument or the player at time corresponding to the detection result, it is possible to provide the computer program that causes the counting system to execute a counting method capable of performing more accurate counting than when the position is not taken into account.

### BRIEF DESCRIPTION OF THE DRAWINGS

The invention will be described with reference to the accompanying drawings, wherein like numbers reference like elements.

FIG. 1 is an explanatory diagram schematically showing the configuration of a form analyzing system according to a first embodiment.

FIG. 2 is a functional block diagram showing a configuration example of the form analyzing system according to the first embodiment.

FIG. 3 is a flowchart for explaining an example of a procedure of a form analyzing method.

FIG. 4 is an explanatory diagram showing a specific example of notification content by an image in the form analyzing method.

FIG. 5 is an explanatory diagram schematically showing the configuration of a putting detecting system according to a second embodiment.

FIG. 6 is a functional block diagram showing a configuration example of the putting detecting system according to the second embodiment.

FIGS. 7A to 7C are explanatory diagrams schematically showing an example of a second detecting device of the putting detecting system.

FIG. 8 is a block diagram showing a configuration example of a second detecting device according to a third embodiment.

FIG. 9 is a block diagram showing a configuration example of a second detecting device according to a fourth embodiment.

FIG. 10 is an explanatory diagram showing a variation of a predetermined member according to a first modification.

FIG. 11 is a diagram for explaining the basic configuration of a second detecting device according to a second modification.

FIG. 12 is an explanatory diagram schematically showing the configuration of a counting system according to a fifth embodiment.

FIG. 13 is a functional block diagram showing a configuration example of the counting system according to the fifth embodiment.

FIG. 14 is a flowchart for explaining an example of a procedure of a number-of-strokes counting method according to the fifth embodiment.

FIG. 15 is a flowchart for explaining an example of a procedure of a number-of-strokes counting method according to a sixth embodiment.

### DESCRIPTION OF EXEMPLARY EMBODIMENTS

### First Embodiment

Exemplary embodiments of the invention are explained below with reference to the drawings. Note that, in the figures referred to below, layers and members are sometimes shown in scales different from actual scales in order to show the layers and the members in recognizable sizes.

### I. Form Analyzing System

### 1. Overview of the System

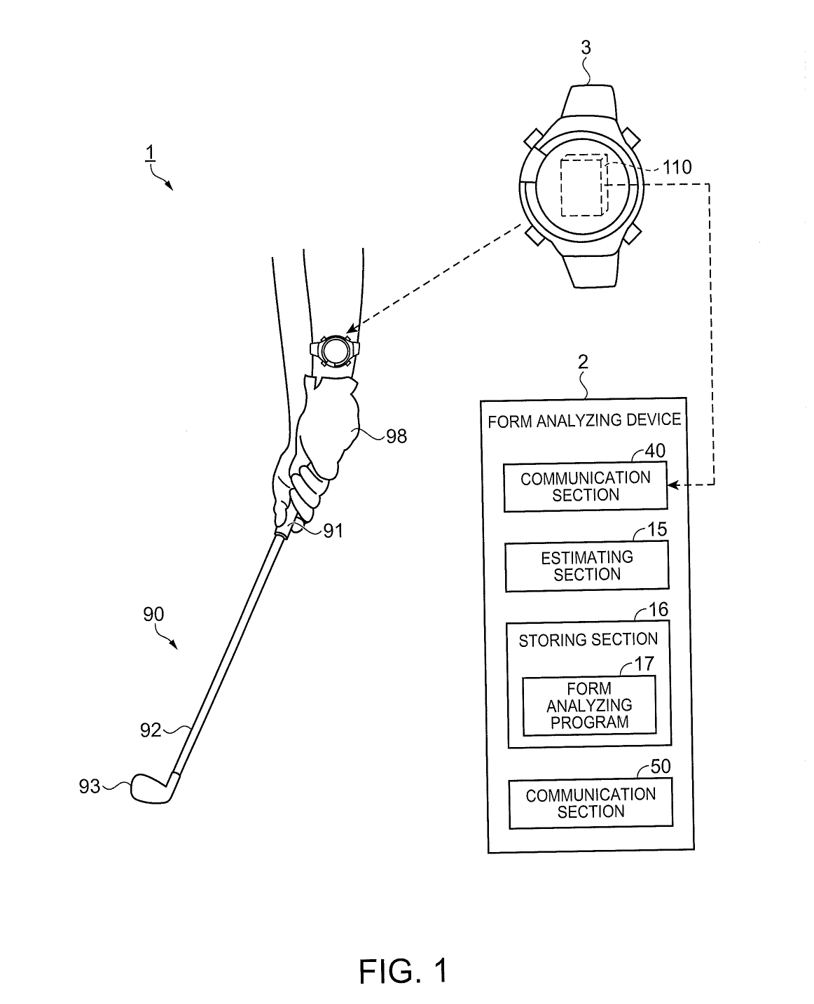

FIG. 1 is an explanatory diagram schematically showing the configuration of a form analyzing system 1 including a form analyzing device 2 according to a first embodiment of the invention.

In FIG. 1, the form analyzing system 1 includes an inertia measuring unit 110 including inertia sensors functioning as physical quantity sensors and a form analyzing device 2 including an estimating section 15, a storing section 16 including a form analyzing program 17, a communication section 40, and a notifying section 50. As the inertia sensors of the inertia measuring unit 110, for example, an acceleration sensor and a gyro sensor are incorporated. The acceleration sensor can detect accelerations respectively in three axial directions orthogonal to one another. The gyro sensor can detect angular velocities respective around three axes orthogonal to one another. The inertia sensors output detection signals. The acceleration and the angular velocity are specified for each of the axes by the detection signals. The acceleration sensor and the gyro sensor relatively accurately detect information concerning the accelerations and the angular velocities.

In this embodiment, the inertia measuring unit 110 is incorporated in a wrist instrument 3 of a wrist type (a wristwatch type) attached to the wrist of a player (a user). The inertia measuring unit 110 only has to be disposed in a place where the inertia measuring unit 110 operates in association with a hitting motion (a swing) by a golf club 90 functioning as a hitting instrument. For example, the inertia measuring unit 110 may be attached to the golf club 90 or may be attached to the back of the hand (the upper limb) of the player via a glove 98 worn on the hand of the player. Alternatively, the inertia measuring unit 110 may be attached to the arm (the upper limb) of the player directly or via clothes by a band or a clip. The golf club 90 includes a shaft 92 and a grip 91 gripped by the hand of the player. The grip 91 is formed coaxially with the axis of the shaft 92. When the inertia measuring unit 110 is attached to the golf club 90, the inertia measuring unit 110 is attached to, for example, the shaft 92 or the grip 91. In the attaching methods explained above, the inertia measuring unit 110 is desirably fixed to be incapable of relatively moving. When the inertia measuring unit 110 is attached, one of detection axes of the incorporated inertia sensors is desirably adjusted to the axis of the shaft 92. The other of the detection axes of the inertia sensors is desirably adjusted to the direction of the face of a club head 93.

The communication section 40 included in the form analyzing device 2 has a function of receiving detection signals from the inertia sensors of the wrist instrument 3 and outputting a part of information generated by the form analyzing device 2 to the wrist instrument 3. The inertia sensors and the form analyzing device 2 are connected by radio by the communication section 40. However, the inertia sensors and the form analyzing device 2 may be connected by wire via an interface circuit.

The form analyzing device 2 includes the storing section 16 and the estimating section 15. The storing section 16 stores, for example, data such as form information in the past in which inertia sensor detection results in the past of the player and forms of swings of the player are associated, the form analyzing program 17, which is a software program for form analysis of a golf swing, and related data. The estimating section 15 extracts, from the storing section 16, the form information in the past corresponding to the present detection result received by the communication section 40. In the form analyzing device 2, the communication section 40, the storing section 16, the estimating section 15, and the notifying section 50 explained below are provided as a computer device. The computer device executes the form analyzing program 17 to execute a form analyzing method.

The storing section 16 includes a DRAM (dynamic random access memory), a large-capacity storage device unit, and a nonvolatile memory. For example, the DRAM temporarily stores the form analyzing program 17 when the form analyzing method is implemented. The large-capacity storage device unit such as a hard disk driving device (HDD) stores the form analyzing program 17 and data. The nonvolatile memory stores a relatively small-capacity program such as a BIOS (a basic input/output system) and data.

The notifying section 50 included in the form analyzing device 2 notifies, with various kinds of notifying means such as sound, an image, and vibration, a player of the present form information based on form information in the past corresponding to a detection result of the present swing performed by the player. Note that the notifying section 50 may be incorporated in the form analyzing device 2 integrated with the notifying section 50 or may be separated from the main body of the form analyzing device 2 and attached in a position where the player can easily grasp notification content.

Note that, in the explanation in this embodiment, the data communication is performed by the radio communication between the inertia measuring unit 110 including the inertia sensors and the form analyzing device 2. As another configuration example, the inertia sensors may be incorporated in the form analyzing device 2. For example, an instrument (in this specification, regarded as a device or a system) may be adopted in which the form analyzing device 2 is integrated with the wrist instrument 3 incorporating the inertia sensors (the inertia measuring unit 110).

### Coordinate Systems

Coordinate systems necessary in the following explanation of embodiments are defined.

e frame (Earth Centered Earth Fixed Frame): a three-dimensional rectangular coordinate system of a right-handed system in which the center of the Earth is set as the origin and the z axis is plotted parallel to the axis of the Earth

n frame (Navigation Frame): a three-dimensional rectangular coordinate system in which a mobile body (a user) is set as the origin and the x axis is set to the North, the y axis is set to the East, and the z axis is set in the gravity direction

b frame (Body Frame): a three-dimensional rectangular coordinate system based on the inertia sensors.

m frame (Moving Frame): a three-dimensional rectangular coordinate system of the right-handed system in which the mobile body (the user) is set as the origin and a moving direction of the mobile body (the user) is set as the x axis

### 2. Configuration of the Form Analyzing System

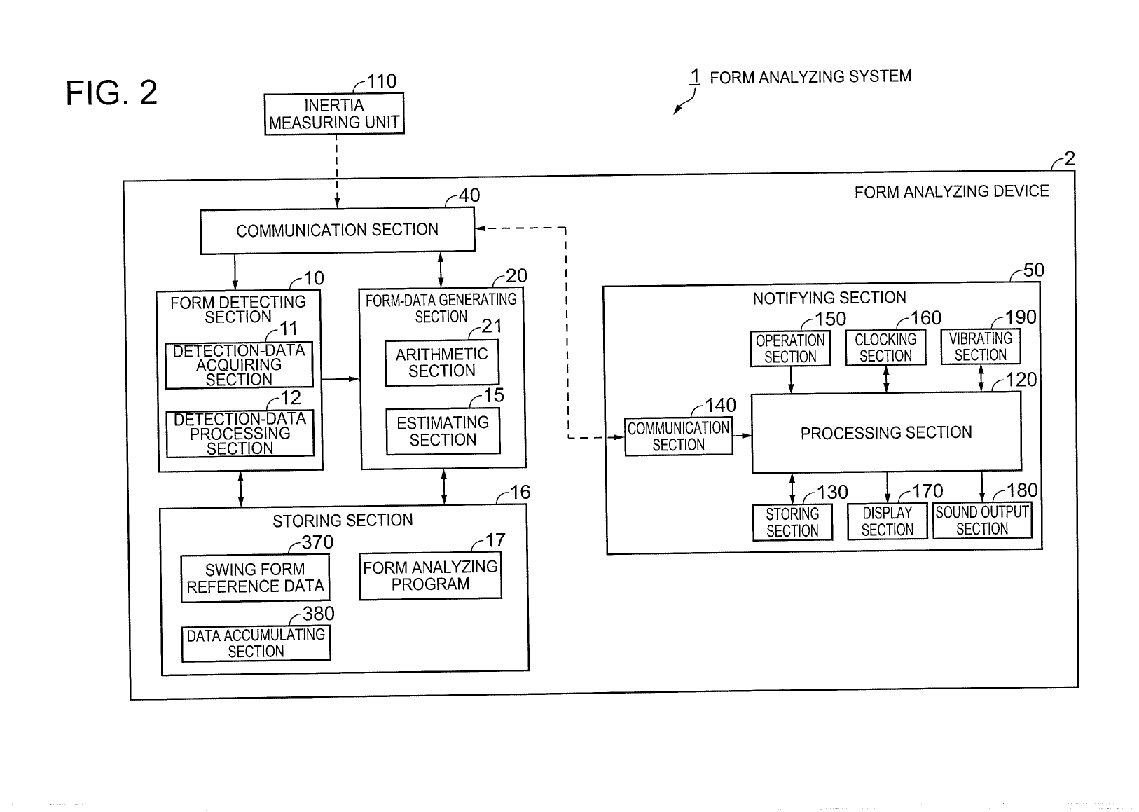

FIG. 2 is a functional block diagram showing a configuration example of the form analyzing system 1.

In the form analyzing system 1 shown in FIG. 2, as the inertia sensors included in the inertia measuring unit 110, as explained above, the acceleration sensor and the angular velocity sensor (the gyro sensor) that detect physical quantities such as acceleration and angular velocity can be used. The acceleration sensor detects accelerations in respective three axial directions crossing (ideally, orthogonal to) one another and outputs a digital signal (acceleration data) corresponding to the magnitudes and the directions of the detected three-axis accelerations. The angular velocity sensor detects angular velocities in respective three axial directions crossing (ideally, orthogonal to) one another and outputs a digital signal (angular velocity data) corresponding to the magnitudes and the directions of the measured three-axis angular velocities.

In the form analyzing system 1, the form analyzing device 2 includes a form detecting section 10, a form-data generating section 20, the storing section 16, the communication section 40, and the notifying section 50. However, in the form analyzing device 2 in this embodiment, a part of these components may be deleted or changed or other components may be added.

The form detecting section 10 includes a detection-data acquiring section 11 that acquires, via the communication section 40, detection data from outputs of the inertia sensors included in the inertia measuring unit 110 and a detection-data processing section 12 that calculates form detection information in which the detection data acquired by the detection-data acquiring section 11 and forms of swings of the player are associated. The form detecting section 10 is connected to the storing section 16 and the form-data generating section 20.

The detection-data processing section 12 receives form detection information including a state of a swing from the detection-data acquiring section 11, calculates, referring to information of swing form reference data 370 of the storing section 16, form detection information in which forms of swings of the player and detection data are associated, and outputs the form detection information to a data accumulating section 380 of the storing section 16 or the form-data generating section 20 as data adjusted to a predetermined format.

Each of the acceleration sensor and the angular velocity sensor of the inertia measuring unit 110 is ideally attached such that the three axes coincide with three axes of a sensor coordinate system (the b frame) based on the inertia measuring unit 110. However, actually, an error of an attachment angle occurs. Therefore, the detection-data processing section 12 performs, using correction parameters calculated in advance according to the attachment angle error, processing for converting data concerning a state of a swing and data concerning an impact (acceleration data and angular velocity data) into data of the sensor coordinate system (the b frame). Note that the form-data generating section 20 explained below may perform the conversion processing on behalf of the detection-data processing section 12.

Further, the detection-data processing section 12 may perform temperature correction processing of the detection-data acquiring section 11. Note that the form-data generating section 20 may perform the temperature correction processing on behalf of the detection-data processing section 12. A function of temperature correction may be incorporated in the detection-data acquiring section 11.

The inertia sensors (the acceleration sensor and the angular velocity sensor) connected to the detection-data acquiring section 11 may output analog signals. In this case, the detection-data processing section 12 or the form-data generating section 20 only has to A/D-convert respective output signals of the inertia sensors and generate sensing data.

The storing section 16 is configured by, for example, various IC memories such as a ROM (Read Only Memory), a flash ROM, and a RAM (Random Access Memory) or storage media such as a hard disk and a memory card.

The storing section 16 includes the swing form reference data 370 read out by the form detecting section 10 and referred to when form detection processing is executed, the data accumulating section 380 in which form information in the past of the player read out by the from-data generating section 20 and referred to when processing for generating the present form information of the player is executed are accumulated, and the form analyzing program 17.

The swing form reference data 370 is reference data such as a threshold referred to when, from detection data output from the inertia sensors of the inertia measuring unit 110 and acquired by the detection-data acquiring section 11 when the form detecting section 10 performs the form detection processing, form detection information in which the detection data and swings of the player are associated is calculated by the detection-data processing section 12.

The form analyzing program 17 is a computer program for causing the form analyzing system 1 to execute a series of form analysis processing (a form analyzing method) explained below.

In the data accumulating section 380, a plurality of kinds of form information in the past of the player, in which detection results in the past of the inertia sensors and forms of swings of the player are associated, output from the form detecting section 10 are accumulated and stored. In the data accumulating section 380, among form information in the past of the player, form information determined as good forms and form information determined as bad forms are at least stored. In this embodiment, a plurality of kinds of the form information determined as the good forms are stored within a predetermined tolerance. As the form information determined as the bad forms, a plurality of kinds of bad form information including all problems of each of events such as address, take-back, down-swing, impact, and follow-through in a swing are stored.

A larger number of kinds of the good form information and the bad form information accumulated in the data accumulating section 380, in particular, the bad form information are accumulated as form information in the past. Therefore, it is possible to extract, using the form information in the past as a database used for the form analysis processing, form information corresponding to the present detection result calculated by the form detecting section 10 from outputs of the inertia sensors, generate more accurate present form information, and notify the player of the present form information.

The form-data generating section 20 includes, for example, an arithmetic section 21 configured by a CPU (Central Processing Unit), a DSP (Digital Signal Processor), and an ASIC (Application Specific Integrated Circuit), and the like and the estimating section 15. The form-data generating section 20 performs, on the basis of the present form detection information of the player acquired from the form detecting section 10, processing for generating the present form information of the player according to the form analyzing program 17 stored in the storing section 16. Specifically, the form-data generating section 20 receives, as data, the present form detection information of the player calculated by the form detecting section 10 on the basis of outputs from the inertia sensors of the inertia measuring unit 110, extracts, with the estimating section 15, the form information in the past corresponding to the received present form detection information from the data accumulating section 380 of the storing section 16, and generates, with the arithmetic section 21, the present form information of the player. Note that the present form information of the player calculated by the arithmetic section 21 may be the form information in the past itself corresponding to the present form detection result extracted from the storing section 16 by the estimating section 15. In this case, the arithmetic section 21 performs processing for deciding the extracted form information in the past as the present form information of the user. The form-data generating section 20 transmits the generated present form information of the player to the notifying section 50 via the communication section 40. The notifying section 50 outputs the received form information in a form of an image, sound, vibration, text, or the like and notifies the player of the form information.

The notifying section 50 includes a processing section 120, a storing section 130, a communication section 140, an operation section 150, a clocking section 160, a display section 170, a sound output section 180, and a vibrating section 190. However, in the notifying section 50 in this embodiment, a part of the components may be deleted or changed or other components may be added.

The processing section 120 performs various kinds of arithmetic processing and control processing in the notifying section 50 according to computer programs stored in the storing section 130. For example, the processing section 120 performs processing for receiving various kinds of processing information (commands for start/stop of form detection, commands for start/end of notification of form information to the player, etc.) corresponding to operation data received from the operation section 150 and sending image data or text data corresponding to the output information to the display section 170, processing for sending sound data corresponding to the output information to the sound output section 180, and processing for sending vibration data corresponding to the output information to the vibrating section 190. The processing section 120 performs, for example, processing for generating time image data corresponding to time information received from the clocking section 160 and sending the time image data to the display section 170.

The storing section 130 is configured by, for example, various IC memories such as a ROM in which computer programs and data for the processing section 120 to perform various kinds of processing are stored and a RAM functioning as a work region of the processing section 120.

The communication section 140 performs data communication with the communication section 40 of the form analyzing device 2. The communication section 140 performs processing for receiving commands (commands for start/stop of form detection, etc.) corresponding to operation data from the processing section 120 and sending the commands to the form analyzing device 2 and processing for receiving the present form information of the player transmitted from the form analyzing device 2 and sending the present form information to the processing section 120.

The operation section 150 performs processing for acquiring operation data (operation data of, for example, start/stop of form detection and selection of display content) from the player and sending the operation data to the processing section 120. The operation section 150 may be, for example, a touch panel display, a button, a key, or a microphone.

The clocking section 160 performs processing for generating time information such as year, month, day, hour, minute, and second. The clocking section 160 is realized by, for example, a real time clock (RTC) IC.

The display section 170 displays image data or text data sent from the processing section 120 as characters, a graph, a table, animation, or other images. The display section 170 is realized by, for example, a display such as an LCD (Liquid Crystal Display), an organic EL (Electroluminescence) display, or an EPD (Electrophoretic Display). The display section 170 may be a touch panel display. Note that the functions of the operation section 150 and the display section 170 may be realized by one touch panel display.

The sound output section 180 outputs, as sound such as voice or buzzer sound, sound data sent from the processing section 120. The sound output section 180 is realized by, for example, a speaker or a buzzer.

The vibrating section 190 vibrates according to vibration data sent from the processing section 120. The vibration is transmitted to a housing that forms the external shape of the notifying section 50. The player wearing the notifying section 50 can feel the vibration. The vibrating section 190 is realized by, for example, a vibration motor.

Note that the notifying section 50 may be replaced with a combination of a computer device or a keyboard, for example, a smart phone, a cellular phone terminal, or a tablet PC (personal computer).

### II. Form Analyzing Method (a Procedure of Processing)

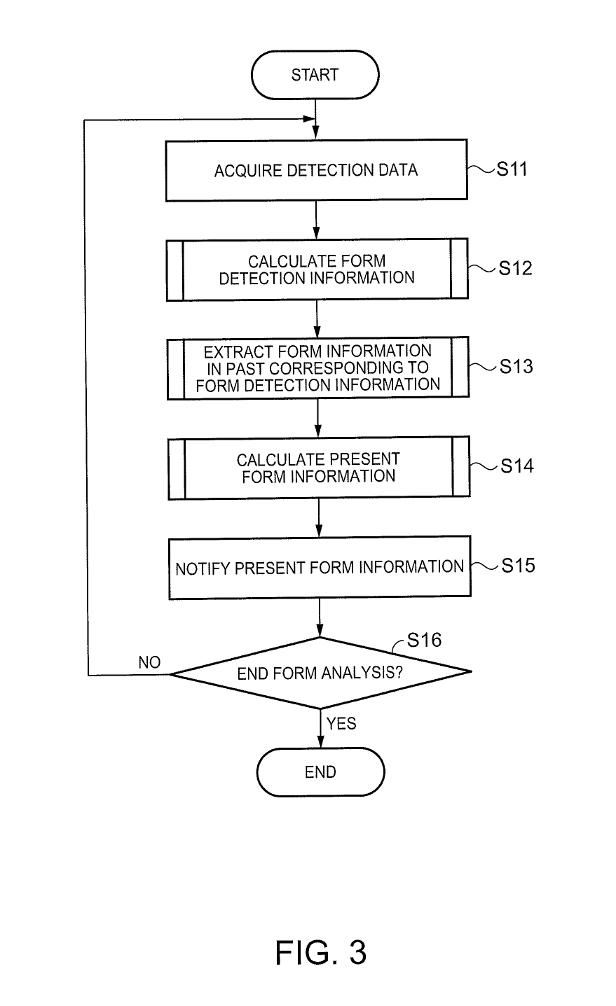

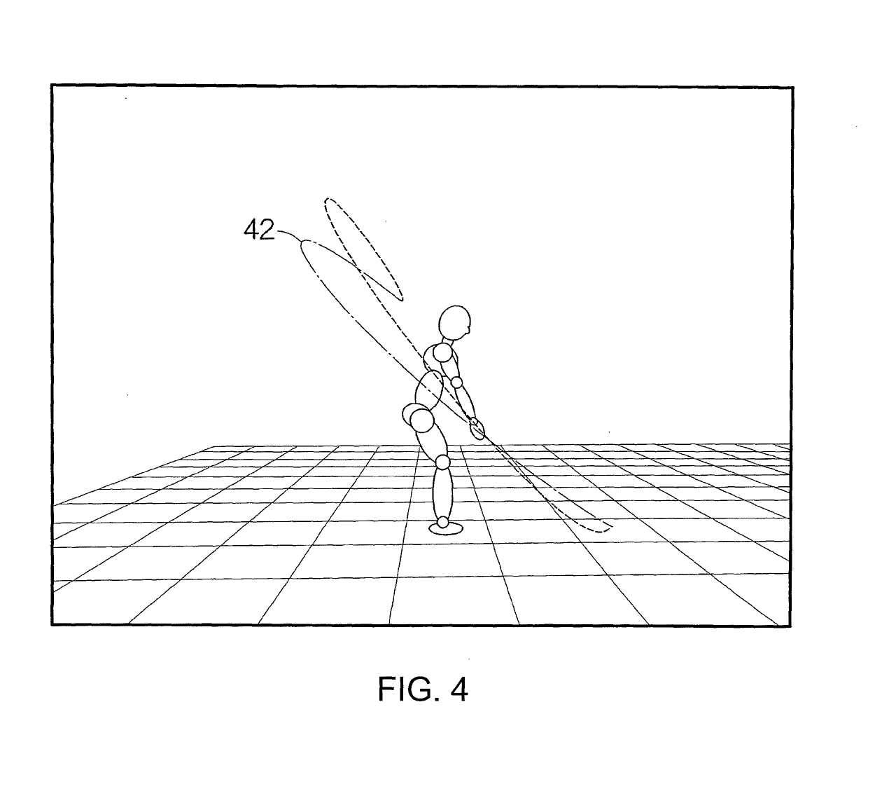

A form analyzing method for analyzing a form of a swing of the player is explained with reference to the drawings. FIG. 3 is a flowchart for explaining an example of a procedure of the form analyzing method performed by the form analyzing system 1 including the form analyzing device 2. FIG. 4 is an explanatory diagram showing a specific example of notification content by an image in the form analyzing method.

The form analyzing system 1 executes the form analyzing program 17 stored in the storing section 16 to thereby execute the form analysis processing according to the procedure of the flowchart of FIG. 3. Note that, in this embodiment, the form analyzing method implemented by the player using the form analyzing system 1, for example, in a round for playing eighteen holes is explained.

In FIG. 3, when receiving a command for a form analysis processing start according to operation of, for example, the operation section 150 of the notifying section 50 by the player, the form analyzing device 2 of the form analyzing system 1 starts the form analyzing method. When the form analyzing method is started, the player performs a swing of the golf club 90 as, for example, a tee shot of a first stroke in a hole of the round. When the player performs the swing of the golf club 90, the inertia sensors of the inertia measuring unit 110 incorporated in the wrist instrument 3 attached to the wrist of the player detects accelerations and angular velocities in three axial directions involved in the swing and outputs a digital signal of angular velocity data corresponding to the magnitudes and the directions of the measured three-axis angular velocities to the form analyzing device 2. In the form analyzing device 2, detection data (angular velocity data) output from the inertia sensors are acquired by the detection-data acquiring section 11 of the form detecting section 10 via the communication section 40 (step S11).

The detection data from the inertia sensors acquired by the detection-data acquiring section 11 is calculated by the detection-data processing section 12 as form detection information associated with a form of a swing of the player with reference to the swing form reference data 370 of the storing section 16 (step S12). The form detection information calculated by the detection-data processing section 12 is output to the form-data generating section 20 as data adjusted to a predetermined format.

When receiving the present form detection information of the player calculated by the form detecting section 10 on the basis of the outputs from the inertia sensors, the form-data generating section 20 extracts, with the estimating section 15, the form information in the past corresponding to the received present form detection information from the data accumulating section 380 of the storing section 16 (step S13). The form-data generating section 20 calculates and generates, with the arithmetic section 21, the present form information of the player on the basis of the extracted form information in the past (step S14).

A plurality of kinds of form information in the past accumulated in the data accumulating section 380 is acquired in advance by the form analyzing system 1 according to a method partially the same as the form analyzing method explained above. Specifically, the detection-data processing section 12 of the form detecting section 10 calculates, with reference to the swing form reference data 307, as form detection information associated with a form of a swing of the player, detection data obtained by detecting a swing of the golf club 90 performed by the player with the inertia measuring unit 110 (the inertia sensors). The detection-data processing section 12 outputs the calculated from detection information to the data accumulating section 380 of the storing section 16 as data adjusted to a predetermined format. It is determined with reference to the swing form reference data 370 whether the form detection information is a good form or a bad form. When it is determined that the form detection information is a bad form, the form detection information is stored in the data accumulating section 380 as information for indicating which of the form of the swing is bad. In this way, in the data accumulating section 380, a plurality of kinds of form information determined as good forms are accumulated within a predetermined tolerance. As the form information determined as the bad forms, a plurality of kinds of form information of bad forms including all problems of each of events such as address, take-back, down-swing, impact, and follow-through in a swing are stored.

Subsequently, in step S15, the present form information of the player generated in step S14 is output to the communication section 140 of the notifying section 50 via the communication section 40. The present form information of the player is notified to the player using any one of notifying units of the notifying section 50. As the notifying unit, any one of the display section 170, the sound output section 180, and the vibrating section 190 of the notifying section 50 can be used or the display section 170, the sound output section 180, and the vibrating section 190 can be used in combination. For example, the display section 170 displays and notifies the present form information of the player as characters, a graph, a table, animation, or other images. The sound output section 180 notifies the present form information of the player as sound such as voice or buzzer sound. The vibrating section 190 functions as an auxiliary notifying unit for notification of the present form information performed using the display section 170 and the sound output section 180. The vibrating section 190 is vibrated in association with the display by the display section 170 or the sound output by the sound output section 180. Consequently, there is an effect that the player wearing the notifying section 50 feels the vibration and urges confirmation of the notification or feels a sense of presence in notification content.

Notification content of the present form information to the player in step S15 is illustrated below. First, a notification example by voice or sound performed using the sound output section 180 as the notifying unit is explained.

First, as a notification example in the case of determination that a form of the present swing is a good form as a result of a swing analysis, praising words and sound such as “nice shot!” and “good job!”, voice of admiration clamors and sound of clapping of galleries, and the like can be illustrated. According to such sound notification, the player can recognize that an analyzed form of a swing of the player is the same as a good form in the past and make use of the form in the next shot. Further, it is possible to expect an effect that the player feels elation and motivation of the player is improved.

As a notification example of the present form information in the case of determination that the form is a bad form, notification by voice of advice information about deviation from good swing information in the past stored as a good swing in the data accumulating section 380 can be illustrated. For example, it is notified in which direction (how) an angle (a shaft rotation angle) of the shaft 92 of the golf club 90 during a swing deviates from the angle in a good form, in which direction (how) an angle of a face surface (a face angle) of the club head 93 of the golf club 90 at the time of an impact deviates from the angle in the good form, or how tempo, rhythm, and size of a swing from address to take-back, top, down-swing, impact, and follow-through are different from those in the good form.

In step S15, the present form information of the player is displayed as characters, a graph, a table, animation, or other images and notified using the display section 170. Therefore, in particular, when it is determined by the form analysis processing that the present form information of the player is a bad form, it is possible to visually clearly notify the player of an advice for urging improvement of the form. For example, as shown in FIG. 4, as notification content of the present form information, an image for visually specifying a moving track 42 of the golf club 90 is rendered by the processing section 120 of the notifying section 50 and projects an image on a screen of the display section 170. With the present form information of the player generated by the form analysis processing in this way, a swing motion is visually represented as an image. The player can easily grasp a difference between form information of a good form in the past of the player and the present form information generated by the form analysis processing of this time.

Subsequently, in step S16, the form analyzing device 2 determines whether to end the form analysis processing, that is, end the play. When the play (the form analysis processing) is continued (No in step S16), the form analyzing device 2 returns to step S11. When the play (the form analysis processing) is ended (Yes in step S16), the form analyzing device 2 ends the series of the form analysis processing (the form analyzing method).

As explained above, with the form analyzing system 1 including the form analyzing device 2 according to this embodiment and the form analyzing method executed by the form analyzing program 17 using the form analyzing system 1, it is possible to obtain effects explained below.

In this embodiment, the form analyzing device 2 and the form analyzing system 1 including the form analyzing device 2 are configured. The form analyzing device 2 includes the data accumulating section 380 of the storing section 16 that stores the form information in the past in which detection results in the past of the inertia sensors (the physical quantity sensors) of the inertia measuring unit 110 attached to the wrist of the player and forms of swings of the player are associated, the estimating section 15 that extracts, from the storing section 16, the form information in the past corresponding to the present detection results of the inertia sensors, and the notifying section 50 that notifies the player of the present form information based on the form information in the past corresponding to the present detection results. The form analyzing method is executed by the form analyzing program 17 using the form analyzing system 1.

Consequently, a plurality of kinds of form information in the past in which detection results in the past of the inertia sensors and forms of swings of the player are associated are stored in the storing section in advance. The form information in the past corresponding to the present detection results of the inertia sensors is extracted out of the plurality of kinds of form information in the past by the estimating section 15. The present form information based on the form information in the past is notified to the player. Consequently, it is possible to perform a swing analysis of the player and notify the user of the present form information, which is a result of the swing analysis, on a real-time basis, urge the player to improve the swing, and improve motivation of the player with a simple configuration in which the wrist instrument 3 incorporating the inertia sensors (the inertia measuring unit 110) is attached to the upper limb or the hitting instrument compared with a large-scale swing analyzing device in the past including, for example, a plurality of sensors attached to parts of a body, an image pickup device, and an image processing device.

It is possible to execute the swing analyzing method, for example, during a round in a golf course and play golf while improving a form of a swing, realization of which is difficult by the form analyzing device in the past.

### Second Embodiment

The schematic configuration of a putting detecting system according to a second embodiment is explained with reference to the drawings. Note that components same as the components in the first embodiment are denoted by the same reference numerals and signs and redundant explanation of the components is sometimes omitted.

### I. Putting Detecting System

### 1. Overview of the System

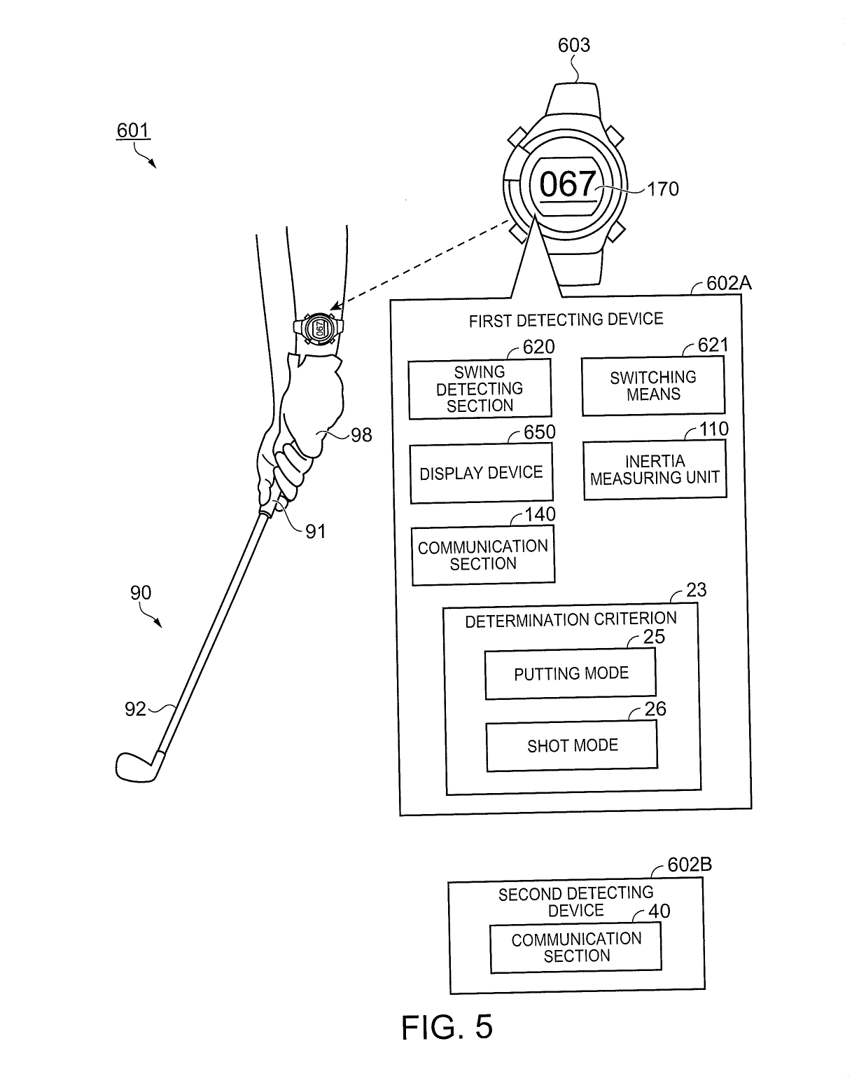

FIG. 5 is an explanatory diagram schematically showing the configuration of a putting detecting system 601 according to this embodiment. As shown in FIG. 5, the putting detecting system 601 in this embodiment includes a wrist instrument 603 including a first detecting device 602A, the inertia measuring unit 110, a switching unit 621, and a display device 650 including the display section 170 and a second detecting device 602B.

The inertia measuring unit 110 includes not-shown inertia sensors. In this embodiment, the inertia measuring unit 110 is incorporated in the wrist instrument 603. However, the inertia measuring unit 110 only has to be associated with a hitting motion by the golf club 90 and attached to a position where an impact of hitting by the golf club 90 can be detected. For example, the inertia measuring unit 110 may be attached to the back of the hand of a player via a glove 68 or may be attached to, for example, the shaft 92 or the grip 91 of the golf club 90.

The first detecting device 602A includes a swing detecting section 620 and a determination criterion 23 for a swing. The swing detecting section 620 receives data concerning a swing and an impact of hitting of the player from the inertia measuring unit 110 and performs detection (swing detection) of physical quantities related to the swing on the basis of the determination criterion 23.

The determination criterion 23 includes at least a putting mode 25, which is a determination criterion for putting, and a shot mode 26, which is a determination criterion for a shot different from the putting.

The second detecting device 602B detects, with various members, an operation section, and the like explained below, whether a swing to be performed by the player is putting. The second detecting device 602B includes the communication section 40. The second detecting device 602B outputs a detection result concerning whether the swing is the putting to the first detecting device 602A via the communication section 40. The first detecting device 602A includes the communication section 140, receives data of the detection result output from the communication section 40 of the second detecting device 602, and switches, on the basis of the data of the detection result, with the switching unit 621, the determination criterion 23 to the putting mode 25 or the shot mode 26.

The first detecting device 602A can present, to the player, in various forms such as characters or a figure displayed on the display section 170 of the wrist instrument 603 or sound or vibration generated by the wrist instrument 603, which of the putting mode 25 and the shot mode 26 the determination criterion 23 is. Consequently, the player can check during a round or during a practice whether a swing to be performed is the putting and whether the determination criterion 23 of the first detecting device 602A is accurately switched.

Note that data communication between the first detecting device 602A and the second detecting device 602B may be radio communication or may be wired communication between the communication section 40 and the communication section 140.

### 2. Configuration of the Putting Detecting System

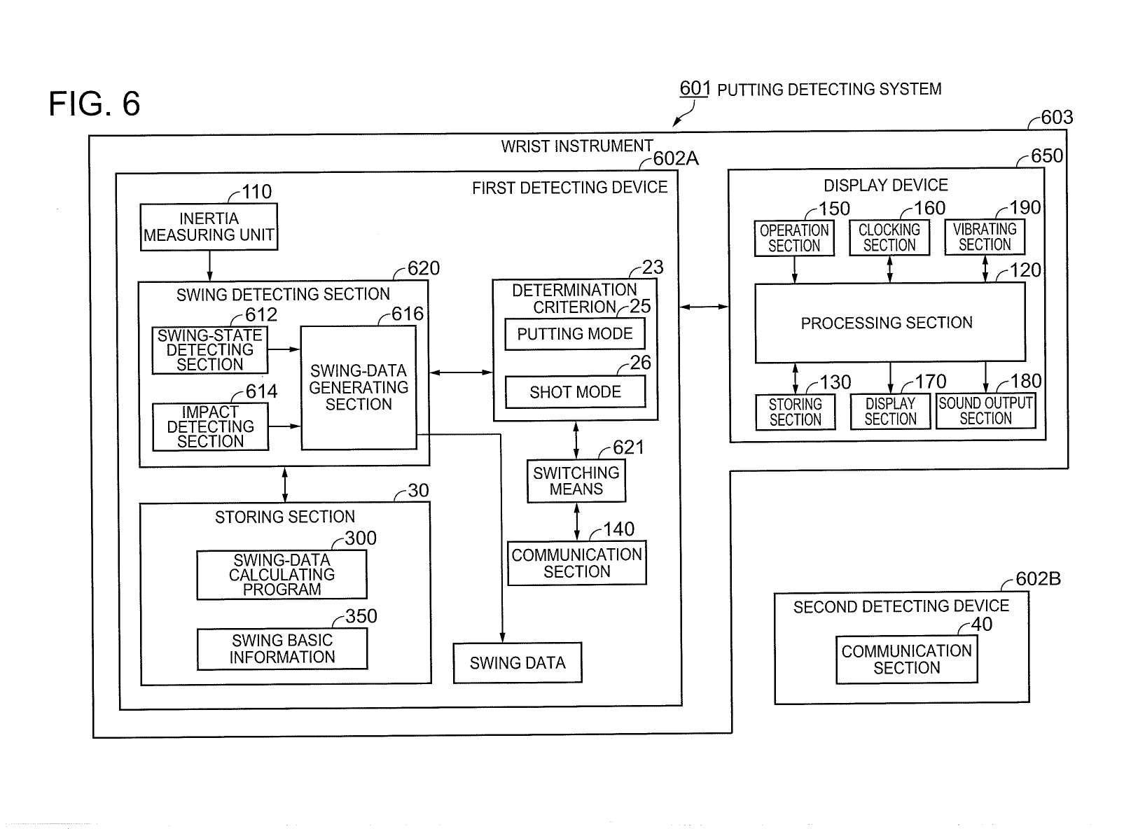

FIG. 6 is a functional block diagram showing a configuration example of the putting detection system 601.

As shown in FIG. 6, the first detecting device 602A includes the swing detecting section 620, a storing section 30, the determination criterion 23, the communication section 140, and the display device 650. However, in the first detecting device 602A in this embodiment, a part of the components may be deleted or changed or other components may be added.

The swing detecting section 620 includes a swing-state detecting section 612 that detects a state of a swing of hitting by the golf club 90 from outputs of the inertia sensors included in the inertia measuring unit 110, an impact detecting section 614 that detects an impact of the hitting by the golf club 90, and a swing-data generating section 616.

As the inertia sensors included in the inertia measuring unit 110, for example, an acceleration sensor and an angular velocity sensor that detect physical quantities such as acceleration and angular velocity can be used. The acceleration sensor detects accelerations in respective three axial directions crossing (ideally, orthogonal to) one another and outputs a digital signal (acceleration data) corresponding to the magnitudes and the directions of the detected three-axis accelerations. The angular velocity sensor detects angular velocities in respective three axial directions crossing (ideally, orthogonal to) one another and outputs a digital signal (angular velocity data) corresponding to the magnitudes and the directions of the measured three-axis angular velocities. In this embodiment, a swing state including the size of the width, a track, and the like of a swing, the strength of an impact, and the like are detected by the inertia sensors (physical quantity sensors) included in the inertia measuring unit 110.

The determination criterion 23 is a determination criterion for swing detection performed by the swing detecting section 620 and includes the putting mode 25, which is a determination criterion in putting, and the shot mode 26, which is a determination criterion in a shot different from the putting. In the determination criterion for swing detection, thresholds of the size of swing width and the strength of an impact in the putting mode are set small (weak) compared with the shot mode.

The swing-data generating section 616 receives data concerning a state of a swing and data concerning an impact respectively from the swing-state detecting section 612 and the impact detecting section 614, refers to the determination criterion of the putting mode 25 or the shot mode 26 of the determination criterion 23 selected via the switching unit 621 on the basis of a detection result by the second detecting device 602B, and generates and outputs swing data adjusted to a predetermined format.

The data concerning the state of the swing and the data concerning the impact output from the swing-state detecting section 612 and the impact detecting section 614 are stored in swing basic information 350 of the storing section 30.

Note that the inertia sensors (the acceleration sensor and the angular velocity sensor) respectively connected to the swing-state detecting section 612 and the impact detecting section 614 may be inertia sensors that output analog signals. In this case, the swing detecting section 620 only has to A/D-convert the output signals of the inertia sensors and generate sensing data.

The storing section 30 is configured by, for example, various IC memories such as a ROM, a flash ROM, and a RAM or storage media such as a hard disk and a memory card. In the storing section 30, a swing-data calculating program 300 read out by the swing detecting section 620 to execute swing data calculation processing by the swing-data generating section 616 is stored.

Besides, the swing basic information 350 and the like are stored in the storing section 30.

The swing detecting section 620 outputs the swing data generated by the swing-data generating section 616 to the display device 650. The display device 650 outputs information based on the received swing data in a form of text, an image, sound, vibration, or the like.

The communication section 40 performs data communication with the communication section 140 of the wrist instrument 603. The communication section 40 performs processing for receiving the information based on the swing data generated by the swing detecting section 620 and transmitting the information to the wrist instrument 603 and processing for receiving data concerning a swing state of the player and an impact measured by the inertia measuring unit 110 transmitted from the wrist instrument 603 and commands for a start, an end, and the like of processing by the first detecting device 602A and sending the data and the commands to the swing detecting section 620.

The display device 650 includes the processing section 120, the storing section 130, the operation section 150, the clocking section 160, the display section 170, the sound output section 180, the vibrating section 190, and the inertia measuring unit 110 including the inertia sensors. However, in the wrist instrument 603 in this embodiment, a part of the components may be deleted or changed or other components may be added.

The processing section 120 performs various kinds of arithmetic processing and control processing. For example, the processing section 120 performs processing for receiving various kinds of processing information corresponding to operation data received from the operation section 150 and sending text data or image data corresponding to the output information to the display section 170, processing for sending sound data corresponding to the output information to the sound output section 180, and processing for sending vibration data corresponding to the output information to the vibrating section 190. The processing section 120 performs, for example, processing for generating time image data corresponding to time information received from the clocking section 160 and sending the time image data to the display section 170.

The storing section 130 is configured by, for example, various IC memories such as a ROM in which computer programs and data for the processing section 120 to perform various kinds of processing are stored and a RAM functioning as a work region of the processing section 120.

The operation section 150 performs processing for acquiring operation data from the player and sending the operation data to the processing section 120. The operation section 150 may be, for example, a touch panel display, a button, a key, or a microphone.

Note that, in the putting detecting system 601 in this embodiment, as explained below, the operation section 150 can also function as the switching unit configured to switch the putting mode 25 and the shot mode 26 of the determination criterion 23.

The clocking section 160 performs processing for generating time information such as year, month, day, hour, minute, and second. The clocking section 160 is realized by, for example, a real time clock (RTC) IC.

The display section 170 displays image data or text data sent from the processing section 120 as characters, a graph, a table, animation, or other images. The display section 170 is realized by, for example, a display such as an LCD (Liquid Crystal Display), an organic EL (Electroluminescence) display, or an EPD (Electrophoretic Display). The display section 170 may be a touch panel display. Note that the functions of the operation section 150 and the display section 170 may be realized by one touch panel display.

The sound output section 180 outputs, as sound such as voice or buzzer sound, sound data sent from the processing section 120. The sound output section 180 is realized by, for example, a speaker or a buzzer.

The vibrating section 190 vibrates according to vibration data sent from the processing section 120. The vibration is transmitted to the wrist instrument 603. The player wearing the wrist instrument 603 can feel the vibration. The vibrating section 190 is realized by, for example, a vibration motor.

As explained above, the second detecting device 602B detects, with various operation sections, members, and the like, whether a swing to be detected by the first detecting device 602A is putting. The second detecting device 602B switches, on the basis of a detection result concerning whether the swing is the putting, with the switching unit 621, the determination criterion 23 to the putting mode 25 or the shot mode 26. For example, when detecting that the swing to be detected by the first detecting device 602A, the second detecting device 602B switches the determination criterion 23 to the putting mode 25 via the switching unit 621. When detecting that the swing to be detected by the first detecting device 602A is a shot different from the putting, the second detecting device 602B switches the determination criterion 23 to the shot mode 26.

### 3. Specific Example of the Second Detecting Device

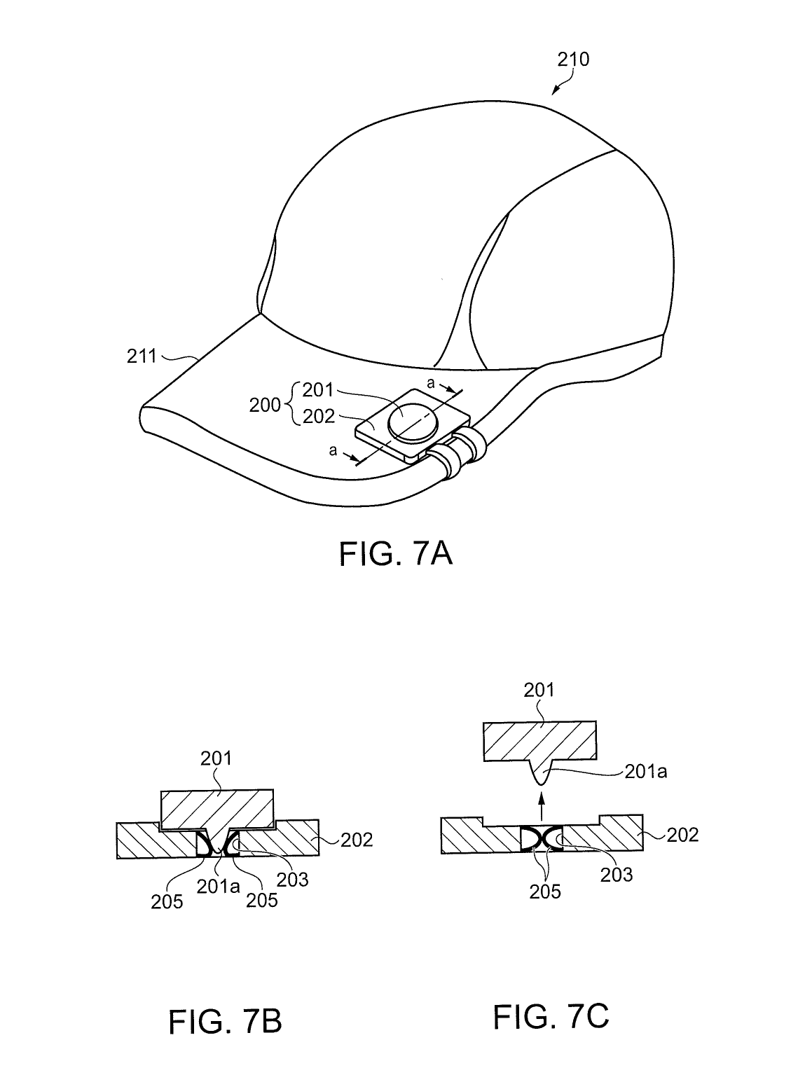

A specific example of the second detecting device 602B in the putting detecting system 601 is explained with reference to the drawings. FIG. 7A is an explanatory diagram schematically showing an example of a second detecting device related to the putting detecting system 601. FIGS. 7B and 7C are sectional views for explaining an a-a line cross section.

In the putting detecting system 601, the second detecting device 602B that detects whether a swing to be performed by the first detecting device 602A is putting (or a shot) can include an attachment section and a predetermined member attachable to and detachable from the attachment section. As shown in FIG. 7A, a ball marker set 200 functioning as the second detecting device in this embodiment is configured by an attachment section 202 and a ball marker 201 attachable to the attachment section 202. In an example explained in this embodiment, the attachment section 202 is attached to a brim 211 of a golf cap 210 by a clip or like and used. However, an attachment section may be provided in the brim 211 of the golf cap 210. The ball marker set 200 is not limited to be attached to the brim 211 of the golf cap 210. For example, the attachment section 202 may be provided in the wrist instrument 603. The ball marker set 200 may be a ball marker set of a sticker type for attaching the attachment section 202 to a chest pocket, a collar, or the like of a jacket. Alternatively, the ball marker set 200 may be a ball marker set of a pendant type including the attachment section 202 as a pendant top.

In the ball marker set 200, when it is detected that the ball marker 201 attached to the attachment section 202 is detached from the attachment section 202, a detection result is output to the switching unit 621 of the first detecting device 602A via a not-shown communication unit. In the ball marker set 200 shown in FIG. 7A, in an attachment state in which a projection 201a provided on the ground surface side of the ball marker 201 is inserted into a recess 203 provided in the attachment section 202, the projection 201a is held in the recess 203 by elasticity of conductive leaf springs 205 provided on the sidewall of the recess 203 to hold the projection 201a from both sides (FIG. 7B). When the ball marker 201 is detached from the attachment section 202, the leaf springs 205 holding the projection 201a from both the sides in the recess 203 of the attachment section 202 come into contact with each other and conduct (FIG. 7C). It is electrically detected that the ball marker 201 is detached from the attachment section 202. A result of the detection is output to the switching unit 621.

Note that an attaching mechanism capable of detecting that the ball marker 201 is detached from the attachment section 202 is not limited to the configuration shown in FIGS. 7B and 7C. Various attaching mechanisms can be used. Detachment of the ball marker 201 from the attachment section 202 may be detected according to a change in a magnetic force using an attaching mechanisms for attaching the attachment section 202 and the ball marker 201 with a magnetic force of a magnet.

During a play before a ball is placed on a green (a putting green) during a round of the player, the ball marker set 200 is carried by the player in a state in which the ball marker 201 is attached to the attachment section 202. When the ball of the player is placed on the green, the ball marker 201 is always placed on the green in order to mark the position of the ball by immediately before the putting. Therefore, the player detaches the ball marker 201 from the attachment section 202 in order to mark the position of the ball with the ball marker 201, whereby it is possible to detect that hitting (a play) performed by the player thereafter is the putting.

As explained above, with the putting detecting system 601 according to this embodiment, it is detected that the ball marker 201 attached to the attachment section 202 of the ball marker set 200 functioning as the second detecting device 602B is detached from the attachment section 202, whereby it is possible to detect that hitting performed by the player thereafter is the putting. Then, the switching unit 621 that receives a result of the detection switches the determination criterion 23 of the first detecting device 602A to the putting mode 25. Therefore, when the player detects the putting without performing any operation and performs the putting on the green, it is possible to accurately perform swing detection of the putting with the putting mode 25, which is the detection criterion for swing detection suitable for the putting.

When swing detection of a shot in which a swing by the player is different from the putting is performed, it is also possible to accurately perform the swing detection at the time of the shot by referring to the shot mode 26, which is the determination criterion for the swing detection suitable for the shot.

Note that, as explained above, the invention includes a computer program for causing the putting detecting system 601 to execute putting detection for detecting, with the second detecting device 602B, whether a swing to be performed by the player next is the putting. With this computer program, it is possible to surely detect with the putting detecting system 601 that the swing is switched to the putting, switch the determination criterion 23 to the putting mode 25 suitable for the putting, and accurately perform the swing detection for the putting.

### Third Embodiment

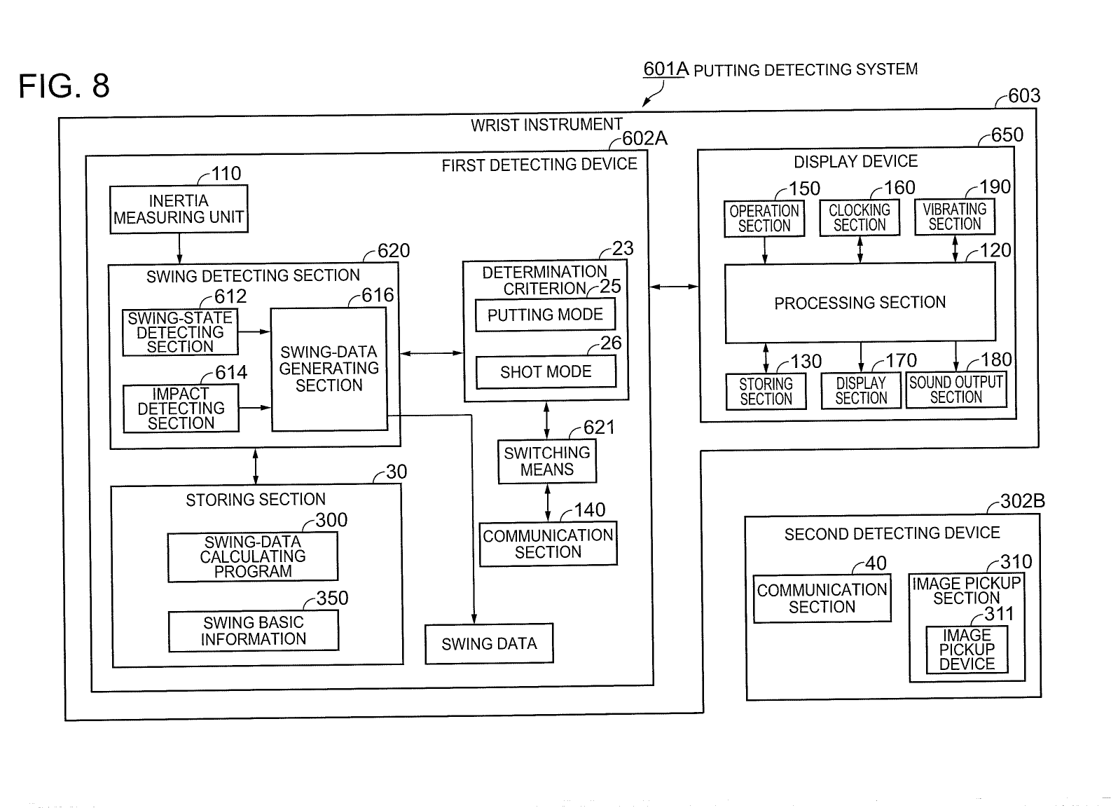

A second detecting device according to a third embodiment is explained. FIG. 8 is a block diagram showing a configuration example of the second detecting device according to the third embodiment.

Note that components same as the components in the second embodiment are denoted by the same reference numerals and signs and redundant explanation of the components is omitted.

In a putting detecting system 601A in the third embodiment shown in FIG. 8, a second detecting device 302B includes an image pickup section 310 including an image pickup device 311. The image pickup section 310 is disposed to be capable of picking up images of objects and places used for putting performed on a green or characteristic states at the time of the putting including the objects and the places. For example, the image pickup section 310 can be disposed in a putter functioning as a hitting instrument, a ball marker, a ball, a cup, a cart, or the like used by a player and configure the putting detecting system 601A. Alternatively, the player may wear the image pickup section 310. For example, the player may attach the image pickup section 310 to clothes worn during a golf play such as a cap and wear or an accessory and use the image pickup section 310.

The image pickup section 310 including the image pickup device 311 of a wearable type such as an HMD (Head Mounted Display) or a smart contact may be used.

When the image pickup device 311 of the image pickup section 310 picks up images of objects or places used for the putting or characteristic states of the objects and the places, the second detecting device 302B detects that hitting performed by the player thereafter is the putting and outputs a result of the detection to the first detecting device 602A as data via the communication section 40. Then, the first detecting device 602A switched the determination criterion 23 to the putting mode 25 via the switching unit 621.

Examples of objects and places used for the putting and a characteristic state at the time of the putting including the objects and the places to be subjected to image pickup by the image pickup device 311 include objects and states explained below. For example, a hitting instrument used for hitting by the player is a putter, a ball marker is placed on the green, a ball is placed on the green, or a state different from a state in which a flagpole (a pin flag) is erected in a hole, that is, a state in which the flagpole is pulled out from the hole or a state in which the flagpole is pulled out from the hole and manually supported and erected near the hole. Such objects and places or states including the objects and the places are characteristic when the putting is performed. Therefore, when images of the objects and the places or the states including the objects and the places are picked up by the image pickup device 311, it is possible to detect that hitting performed by the player thereafter is the putting.

According to this embodiment, all of the targets subjected to image pickup by the image pickup device 311 are objects and places always used by immediately before the putting or objects and places that change in states, for example, are detached at the time of the putting. Therefore, according to image pickup of the objects and the places or the change in the states by the image pickup device, it is possible to detect the putting and switch the determination criterion of the switching detecting section to the putting mode 25.

### Fourth Embodiment

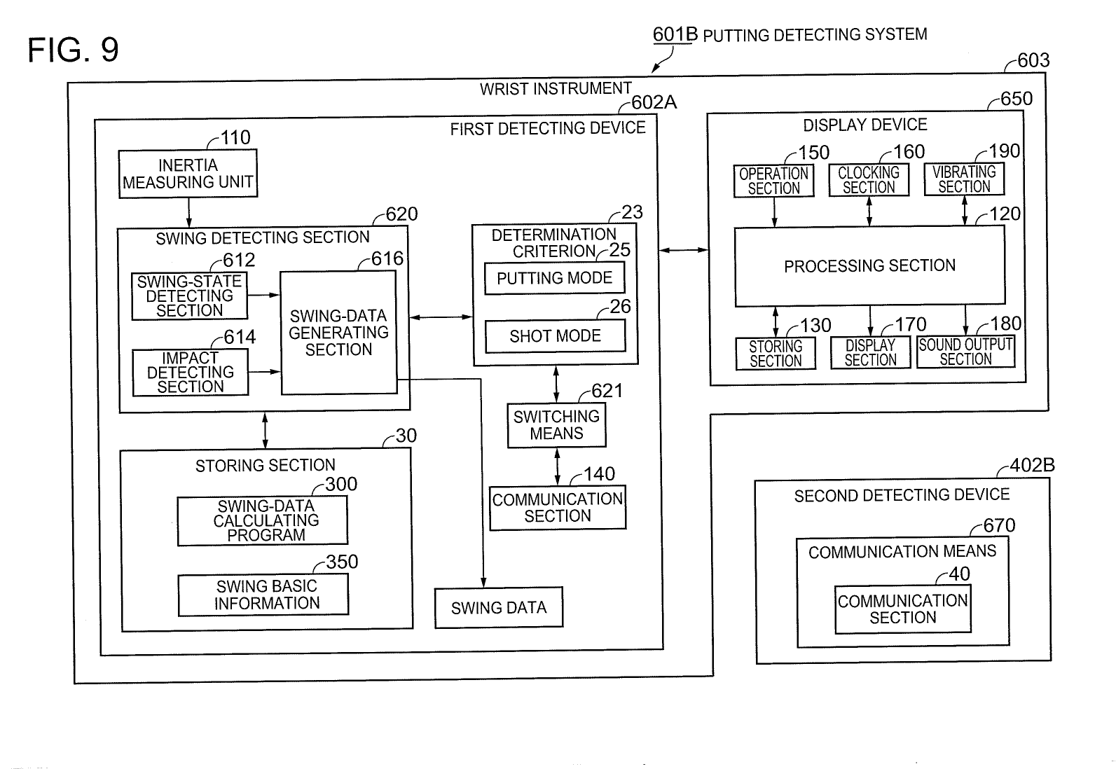

A second detecting device according to a fourth embodiment is explained with reference to the drawings. FIG. 9 is a block diagram for explaining the second detecting device according to the fourth embodiment.

Note that components same as the components in the second embodiment are denoted by the same reference numerals and signs and explanation of the components is omitted.

A second detecting device 402B in a putting detecting system 601B in the third embodiment shown in FIG. 9 includes a communication unit 670 including the communication section 40 served for communication (transmission and reception) with the first detecting device 602A. The communication unit 670 is disposed in an object, a place, or the like used for putting performed on a green.

For example, the communication unit 670 can be disposed in a putter, a ball marker, a ball, a cup, or the like to configure the putting detecting system 601B. When predetermined communication is performed between the communication unit 670 and the first detecting device 602A, the second detecting device 402B can detect that hitting performed by the player thereafter is the putting and switch the determination criterion 23 for swing detection by the swing detecting section 620 to the putting mode 25 via the switching unit 621.

Note that the second detecting device 402B may configure, with the communication unit 670, a putting detecting unit configured to detect that hitting performed by the player thereafter is the putting and output, with the communication section 40, a result of the detection to the first detecting device 602A as data.

Examples of predetermined communication performed between the communication unit 670 and the first detecting device 602A in order to detect the putting include the following corresponding to objects and places on which the communication unit 670 is disposed.

For example, when the communication unit 670 is disposed in a putter, when the player holds the grip 91 of the putter in a grip position for the putting for a predetermined time, the second detecting device 402B detects that the next hitting of the player is the putting and performs communication for outputting, with the communication unit 670, a result of the detection to the first detecting device 602A.

Besides, the second detecting device 402B can measure the distance between the putter and the first detecting device 602A through communication between the communication unit 670 disposed on the putter and the first detecting device 602A and, when the distance is within a predetermined distance, detect that the next hitting of the player is the putting.

When the communication unit 670 is disposed on the ball marker, when confirming through communication by the communication unit 670 that the position of the ball marker is present on the green or the ball marker is detected from an attachment section to which the ball marker is attached or when the distance between the ball marker and the first detecting device 602A is measured through communication between the communication unit 670 disposed on the ball marker and the first detecting device 602A and it is confirmed that the distance is within a predetermined range, the second detecting device 602B can detect that the next hitting of the player is the putting.

In the configuration in which the communication unit 670 is incorporated in the ball or the configuration in which the communication unit 670 is disposed in the cup, it is possible to measure the distance between the cup and the ball, between the cup and the ball marker, or between the cup and the putter through communication of the communication unit 670 and, for example, when the measured distance is within a predetermined range, detect that hitting performed by the player thereafter is the putting.

As explained above, in the second detecting device 402B, the communication unit 670 is used as a putting detecting unit configured to detect whether the next hitting of the player is the putting and a communication unit configured to output a result of the putting detection to the first detecting device 602A and the switching unit 621 as a signal.

With the putting detecting system 601B including the second detecting device 402B including the communication unit 670 in this embodiment, it is possible to configure and provide, in a variety of variations, the putting detecting device that detects whether the next hitting of the player is the putting and, when it is determined that the next hitting is the putting, switches the determination criterion, which is referred to in the swing detection executed by the first detecting device 602A, to the putting mode 25.

Note that the invention is not limited to the embodiments and various changes, improvements, and the like can be added to the embodiment. Modifications are explained below.

### First Modification

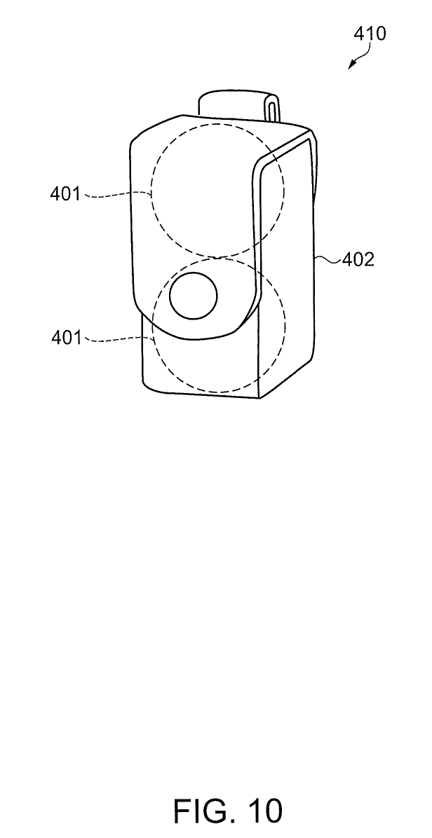

FIG. 10 is an explanatory diagram showing a variation of a predetermined member according to a first modification.

In the second embodiment, as shown in FIGS. 7A to 7C, as the specific example of the second detecting device 602B, the configuration including the attachment section 202 and the ball marker 201 functioning as the predetermined member attachable and detachable to the attachment section 202 is explained. However, the second detecting device 602B is not limited to this configuration.

A ball set 410 functioning as a second detecting device according to the first modification is explained below. Note that, in the following explanation of the first modification, components same as the components in the second embodiment are denoted by the same reference numerals and signs and redundant explanation of the components is omitted.

In FIG. 10, the ball set 410 as a modification of the second detecting device includes a ball 401 functioning as a predetermined member, and a ball case 402 functioning as an attachment section that stores the ball 401 and can be carried by a player. The ball 401 in this modification is used as a ball exclusive for putting. In a round of the player, at the start of the putting after a ball (a ball different from the ball 401) placed on a green for the first time is marked by a ball marker, the ball 401 is placed in a position marked by the marker and thereafter used for the putting. Therefore, the ball 401 of the ball set 410 in this modification is not used in an official round performed as a competitive sport and is used for only the putting after informing players playing together of the ball 401 in a practice round, a competition performed by close relatives, or the like.

In the putting detection system 601, it is detected according to taking-out (detachment) of the ball 401 exclusive for putting stored in the ball case 402 from the ball case 402 whether a swing to be detected by the first detecting device 602A is the putting. That is, when the ball 401 is taken out from the ball case 402, it is detected that hitting to be performed by the player next is the putting. A result of the detection is output to the switching unit 621 as a signal via a not-shown communication section. Note that, as an attaching mechanism capable of detecting that the ball 401 is taken out from the ball case 402, it is possible to apply various mechanisms such as a mechanism in which, when the ball 401 is stored in the ball case 402, contacts do not come into contact with each other and, when the ball 401 is taken out from the ball case 402, it is electrically detected that the contacts come into contact with each other and conduct.

With the ball set 410, it is detected that hitting performed by the player thereafter is the putting. When a result of the detection is output to the switching unit 621, the switching unit 621 switches the determination criterion 23 for swing detection by the swing detecting section 620 of the first detecting device 602A to the putting mode 25 (see FIG. 6). The swing detecting section 620 of the first detecting device 602A receives data concerning a state of a swing and an impact from the swing-state detecting section 612 and the impact detecting section 614, refers to the putting mode 25, which is the determination criterion for putting of the determination criterion 23, and generates and outputs swing data.

With the ball set 410 in the first modification, when the player uses the ball 401 for putting at the time of the putting, it is possible to detect that the player starts the putting, switch the determination criterion to the putting mode 25, and suppress misdetection of swing detection of the putting and perform accurate swing detection according to the putting mode 25, which is the determination reference for swing detection suitable for the putting.

### Second Modification

In the embodiments and the first modification, the start of the putting of the player is detected by detecting or picking up images of the objects and the places used for the putting performed on the green or the characteristic states at the time of the putting including the objects and the places. However, the detection of the putting is not limited to this.

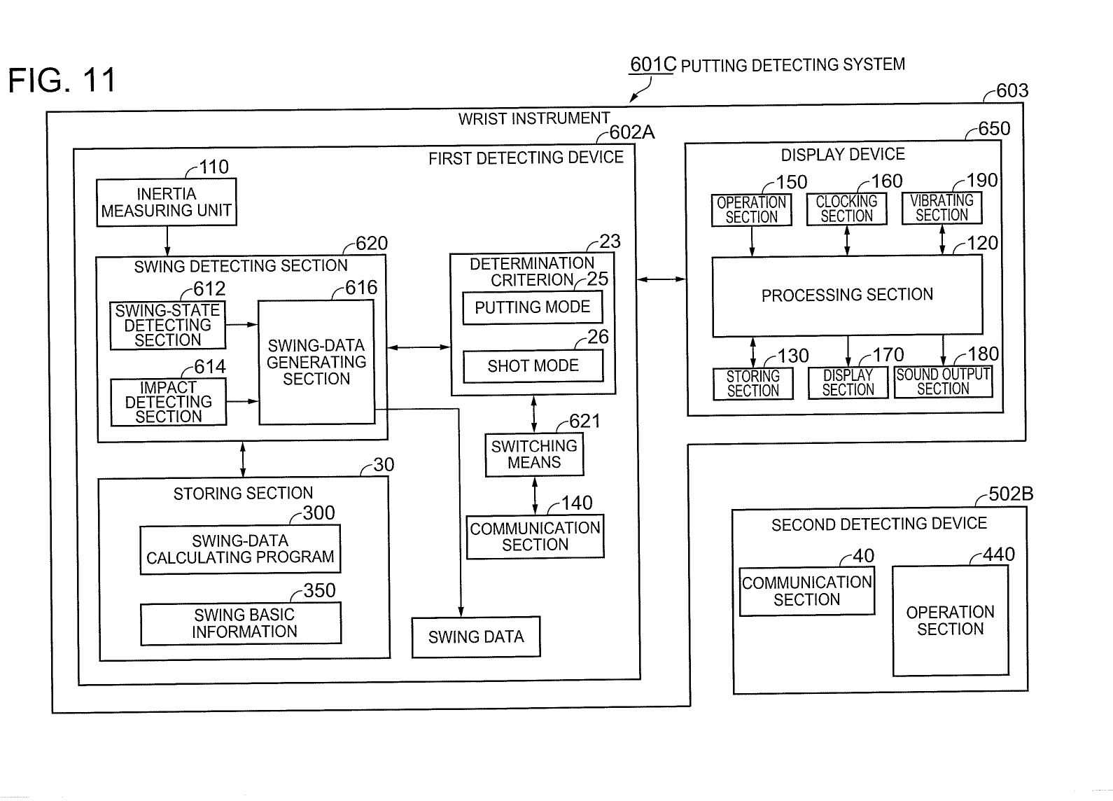

A variation of a second detecting device according to the second modification is explained below. FIG. 11 is a diagram for explaining the basic configuration of the second detecting device according to the second modification.

In the second detecting device in the second modification in a putting detecting system 601C, when a player starts putting, the player operates an operation section to switch a determination criterion to the putting mode 25 according to the operation. In FIG. 11, a second detecting device 502B in the putting detecting system 601C includes an operation section 440. When the player starts the putting, the operation section 440 of the second detecting device 502B is operated by the player. Switching unit 621 switches a determination criterion for swing detection by the swing detecting section 620 of the first detecting device 602A to the putting mode 25 according to the operation. Note that not only the player but also a related person such as a caddie accompanying the player may operate the operation section 440.

As the operation section 440, various forms operable by the player can be applied. For example, the player operates, using a push button, a switching knob, a snap switch, or the like as the operation section 440, the operation section 440 to detect the putting. When the second detecting device 502B includes a touch panel, the player performs, using the touch panel as the operation section 440, basic operation of the touch panel such as tap, flick, and drag to thereby detect the putting.

In another form of the second modification, the second detecting device 602B of the putting detecting system 601 shown in FIG. 6 is removed. The display device 650 is used as the second detecting device. When the player starts the putting, the player operates the operation section 150 of the display device 650 to switch, with the switching unit 621, the determination criterion 23 to the putting mode 25.

The operation section that the player operates to start the putting is not limited to the operation section 150 of the display device 650. For example, the display device 650 may be the display device 650 of a wristwatch type attached with a rotary bezel. The player may use the rotary bezel as the operation section and turn the rotary bezel to a predetermined position to thereby detect the putting. If the rotary bezel is used as the operation section, there is an advantage that display of the operation section for detecting the putting is easily visually recognized even in the daytime of a fine weather compared with, for example, liquid crystal display.

With the putting detecting system 601C including the second detecting device 508B in the second modification, the player who recognizes that a swing to be performed is the putting can switch the determination criterion 23 to the putting mode by operating the operation section 440.

### 4. Putting Detecting Device

In the embodiments and the modifications, the putting detecting systems 601, 601A, 601B, and 601C are explained that, when the swing detection of the player is performed, detect whether a swing to be performed is the putting and, when detecting that the swing is the putting, switch the determination criterion in the swing detection to the putting mode 25. It is possible to configure and provide a putting detecting device that includes, among the components of the putting detecting systems in the embodiments and the modifications, for example, at least the swing detecting section 620, the determination criterion 23 including the putting mode 25 and the shot mode 26, and the switching unit 621 shown in FIGS. 5 and 6 to thereby attain an effect of improving detection accuracy when detecting physical quantities of a swing on the basis of the determination criterion 23.

In the putting detecting device having this configuration, the various putting detecting unit in the second detecting device explained in the embodiments and the modifications are applied to the switching unit 621. When the putting detecting unit detects the putting, the putting detecting unit functions as a unit configured to switch the determination criterion 23 from the shot mode 26 to the putting mode 25.

For example, the switching unit 621 in the putting detecting device may detach the ball marker 201 functioning as the predetermined member attached to the attachment section 202 as in the ball marker set 200 in the second modification.

With this configuration, the ball marker 201 detached from the attachment section 202 when the swing is switched to the putting is applied as the predetermined member. Therefore, according to the operation for detaching the ball marker 201 from the attachment section 202, it is possible to detect that the swing is switched from the shot to the putting. It is possible to automatically surely perform the switching of the determination criterion 23 to the putting mode 25. The predetermined member may be a flagpole or a golf ball besides the ball marker 201. When the flagpole is the predetermined member, the attachment section is an attachment section for erecting the flagpole of a hole. When the golf ball is the predetermined member, the attachment section is the ball case 402 in the first modification.

The switching unit 621 in the putting detecting device may be the image pickup section 310 including the image pickup device 311 included in the second detecting device 302B explained in the third embodiment. With this configuration, when images of the objects and the places used for the putting performed on the green or the characteristic states of the objects and the places are picked up by the image pickup device 311, it is possible to detect the putting and switch the determination criterion 23 to the putting mode 25.

The switching unit 621 in the putting detecting device may be, in the second detecting device 502B in the second modification, the operation section 440 that the player operates to switch the determination criterion to the putting mode 25 when the player starts the putting.

With this configuration, the player who recognizes that a swing to be performed is the putting can switch the determination criterion to the putting mode by operating the operation section 440.

The switching unit 621 in the putting detecting device may be communication with the operation section 440 and the predetermined member.

With this configuration, it is possible to configure, in a variety of variations, the putting detecting device that detects the putting and switches the determination criterion 23 to the putting mode 25 through communication with the various predetermined members capable of detecting that the swing is switched to the putting.

The putting detecting device includes the switching unit 621 for switching, when physical quantities related to a swing of a hitting instrument (a golf club or a putter) are detected by the swing detecting section 620 on the basis of the determination criterion 23 including the putting mode 25 and the shot mode 26, the determination criterion 23 to the putting mode 25 when it is determined that the swing by the hitting instrument is the putting. Consequently, when a swing of the player is the putting, the determination criterion 23 for swing detection is switched from the shot mode 26 to the putting mode 25 suitable for the putting. Therefore, it is possible to accurately perform the swing detection for the putting.

### Fifth Embodiment

First, the schematic configuration of a counting system according to a fifth embodiment is explained with reference to the drawings. Note that components same as the components in the embodiments are denoted by the same reference numerals and signs and redundant explanation of the components is omitted.

### I. Counting System

### 1. Overview of the System

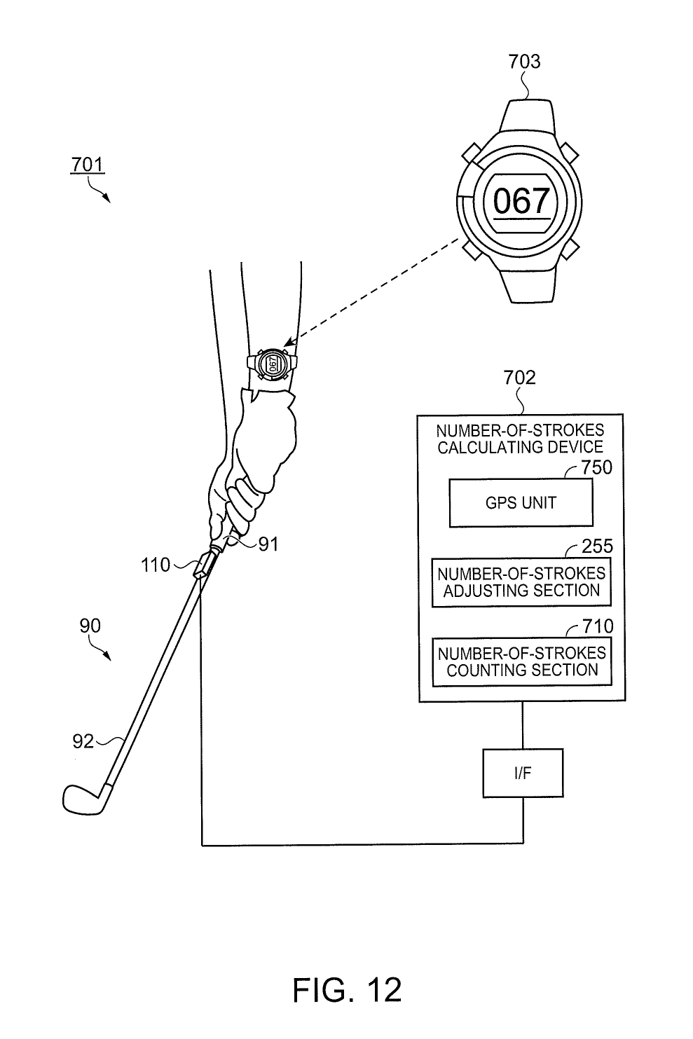

FIG. 12 is a diagram for explaining the overview of a counting system 701 in this embodiment. As shown in FIG. 12, the counting system 701 in this embodiment includes the inertia measuring unit 110 including the inertia sensors, a number-of-strokes calculating device 702, and a display device 703. Note that the number-of-strokes calculating device 702 includes a number-of-strokes counting section 710 functioning as a counting section, a GPS unit 750 functioning as a positioning device, and a number-of-strokes adjusting section 255. Details of these components are explained below.

The inertia measuring unit 110 in this embodiment is attached to a position closer to the grip 91 of the shaft 92 of the golf club 90 functioning as a hitting instrument. However, the inertia measuring unit 110 only has to be attached to a place where the inertia measuring unit 110 operates in association with a hitting motion (movement of the hitting instrument) by the golf club 90. For example, the inertia measuring unit 110 may be attached to the back of the hand of a player via a glove 98 (another example of the hitting instrument). When the display device 703 is attached to the arm as in this embodiment, the display device 703 and the inertia measuring unit 110 may be integrated.

The number-of-strokes calculating device 702 in this embodiment is attached to a trunk portion (e.g., the right waist, the left waist, or the center of the waist) of the player (a user). However, the number-of-strokes calculating device 702 can be manufactured in various shapes and can be attached to various parts of the body of the player or a mobile body that moves according to the movement of the player.

The display device 703 in this embodiment is a portable information instrument of a wrist instrument type (a wristwatch type) and is attached to the wrist or the like of the player. However, the display device 703 may be a portable information instrument such as a head mount display (HMD) or a smart phone.

The player can operate the display device 703 during a play and instruct a start and a stop of counting of the number of strokes and various kinds of measurement (inertia navigation arithmetic processing, number-of-strokes calculation processing, etc. explained below) by the number-of-strokes calculating device 702.

The player can check, with the display device 703, on a real-time basis, the number of strokes of a golf play of the player calculated by the number-of-strokes calculating device 702.

Further, the player can instruct (input) adjustment or correction of a number-of-strokes count value by the number-of-strokes calculating device 702 by operating the display device 703 according to necessity.

When receiving a command for a number-of-strokes count start, the number-of-strokes calculating device 702 counts the number of strokes on the basis of a state of a swing and timing of an impact detected from information concerning acceleration and velocity obtained from outputs of the inertia sensors of the inertia measuring unit 110, refers to positioning information calculated by the GPS unit 750, separately-input information concerning a hole (hole data), basic information of a swing of the player, and the like, and adjusts the number-of-strokes count value according to necessity to generate the number of strokes of the player. The number-of-strokes calculating device 702 transmits the generated number of strokes to the display device 703. The display device 703 receives the number-of-strokes data and presents the received number-of-strokes data to the player in various forms such as characters, a figure, sound, and vibration. The player can recognize an accurate number of strokes of the player via the display device 703 during a round or during a practice.

Note that data communication between the number-of-strokes calculating device 702 and the display device 703 may be radio communication or may be wired communication. As another configuration example, the number-of-strokes calculating device 702 and the display device 703 may be integrated. When an attached place of the display device 703 is, for example, the wrist, an instrument (in this specification, regarded as a system) may be adopted in which the inertia measuring unit 110, the number-of-strokes calculating device 702, and the display device 703 are integrated.

In this embodiment, in the following explanation, an example is explained in detail in which the counting system 701 including the number-of-strokes calculating device 702 generates the number of strokes on the basis of sensor outputs and a positioning result during a round of a golf of the player. The counting system 701 in this embodiment can also be applied when accurate number-of-strokes data is generated in, for example, during a half round of nine holes, a practice in only one hole, and the like other than a round for playing eighteen holes.

### 2. Configuration of the Counting System

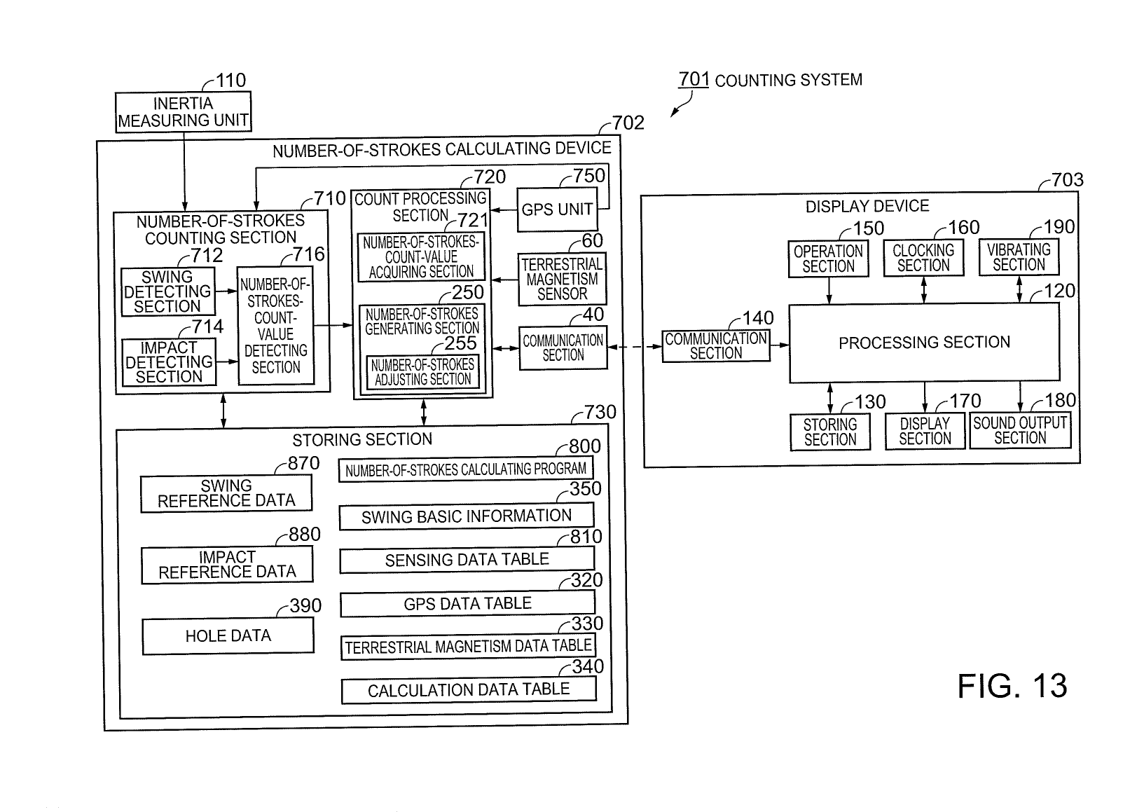

FIG. 13 is a functional block diagram showing a configuration example of the counting system 701 including the number-of-strokes calculating device 702 and the display device 703.

As shown in FIG. 13, the number-of-strokes calculating device 702 includes the number-of-strokes counting section 710, a count processing section 720, a storing section 730, the communication section 40, a GPS (Global Positioning System) unit 50, and a terrestrial magnetism sensor 60. The count processing section 720 includes a number-of-strokes-count-value acquiring section 721 and a number-of-strokes generating section 250 including a number-of-strokes adjusting section 255. However, the number-of-strokes calculating device 702 in this embodiment may have a configuration in which a part of the components are deleted or changed or other components are added.

The number-of-strokes counting section 710 includes a swing detecting section 712 that detects a state of a swing of hitting by the golf club 90 from outputs of the inertia sensors included in the inertia measuring unit 110, an impact detecting section 714 that detects an impact of the hitting by the golf club 90, and a number-of-strokes-count-value detecting section 716 that counts the number of strokes on the basis of detection results of the swing and the impact by the swing detecting section 712 and the impact detecting section 714.

As the inertia sensors included in the inertia measuring unit 110, for example, an acceleration sensor and an angular velocity sensor that detect physical quantities such as acceleration and angular velocity can be used. The acceleration sensor detects accelerations in respective three axial directions crossing (ideally, orthogonal to) one another and outputs a digital signal (acceleration data) corresponding to the magnitudes and the directions of the detected three-axis accelerations. The angular velocity sensor detects angular velocities in respective three axial directions crossing (ideally, orthogonal to) one another and outputs a digital signal (angular velocity data) corresponding to the magnitudes and the directions of the measured three-axis angular velocities.

The number-of-count-value detecting section 716 receives data concerning the state of the swing and data concerning the impact respectively from the swing detecting section 712 and the impact detecting section 714, generates counting data of the number of strokes adjusted to a predetermined format referring to information of impact reference data 880 and swing reference data 870 of the storing section 730, and outputs the counting data to the count processing section 720.

The data concerning the state of the swing and the data concerning the impact output from the swing detecting section 712 and the impact detecting section 714 are added with time information input from the GPS unit 750 and are stored in the swing basic information 350 of the storing section 730.

Each of the acceleration sensor and the angular velocity sensor of the inertia measuring unit 110 is ideally attached such that the three axes coincide with three axes of a sensor coordinate system (the b frame) based on the inertia measuring unit 110. However, actually, an error of an attachment angle occurs. Therefore, the number-of-strokes-count-value detecting section 716 performs, using correction parameters calculated in advance according to the attachment angle error, processing for converting the data concerning the state of the swing and the data concerning the impact (acceleration data and angular velocity data) into data of the sensor coordinate system (the b frame). Note that the count processing section 720 explained below may perform the conversion processing on behalf of the number-of-strokes-count-value detecting section 716.

Further, the number-of-strokes-count-value detecting section 716 may perform temperature correction processing of the swing detecting section 712 and the impact detecting section 714. Note that the count processing section 720 may perform the temperature correction processing on behalf of the number-of-strokes-count-value detecting section 716. A function of temperature correction may be incorporated in the swing detecting section 712 and the impact detecting section 714.

The inertia sensors (the acceleration sensor and the angular velocity sensor) respectively connected to the swing detecting section 712 and the impact detecting section 714 may output analog signals. In this case, the number-of-strokes-count-value detecting section 716 or the count processing section 720 only has to A/D-convert respective output signals of the inertia sensors and generate sensing data.

The GPS unit 750 receives a GPS satellite signal transmitted from a GPS satellite, which is a type of a positioning satellite, performs positioning calculation using the GPS satellite signal to calculate a position and velocity (vectors including magnitudes and directions) of the player in n frames, and outputs, to the count processing section 720, GPS data obtained by adding time information and positioning accuracy information to the position and the velocity. Note that a method of calculating a position and velocity using the GPS and a method of generating time information using the GPS are publicly known. Therefore, detailed explanation of the methods is omitted.

The terrestrial magnetism sensor 60 detects terrestrial magnetisms in three axial directions crossing (ideally orthogonal to) one another and outputs a digital signal (terrestrial magnetism data) corresponding to the magnitudes and the directions of the detected three-axis terrestrial magnetisms to the count processing section 720. However, the terrestrial magnetism sensor 60 may output analog signals. In this case, the count processing section 720 may A/D-convert the output signals of the terrestrial magnetism sensor 60 and generate terrestrial magnetism data.

The storing section 730 is configured by, for example, various IC memories such as a ROM (Read Only Memory), a flash ROM, and a RAM (Random Access Memory) or storage media such as a hard disk and a memory card.

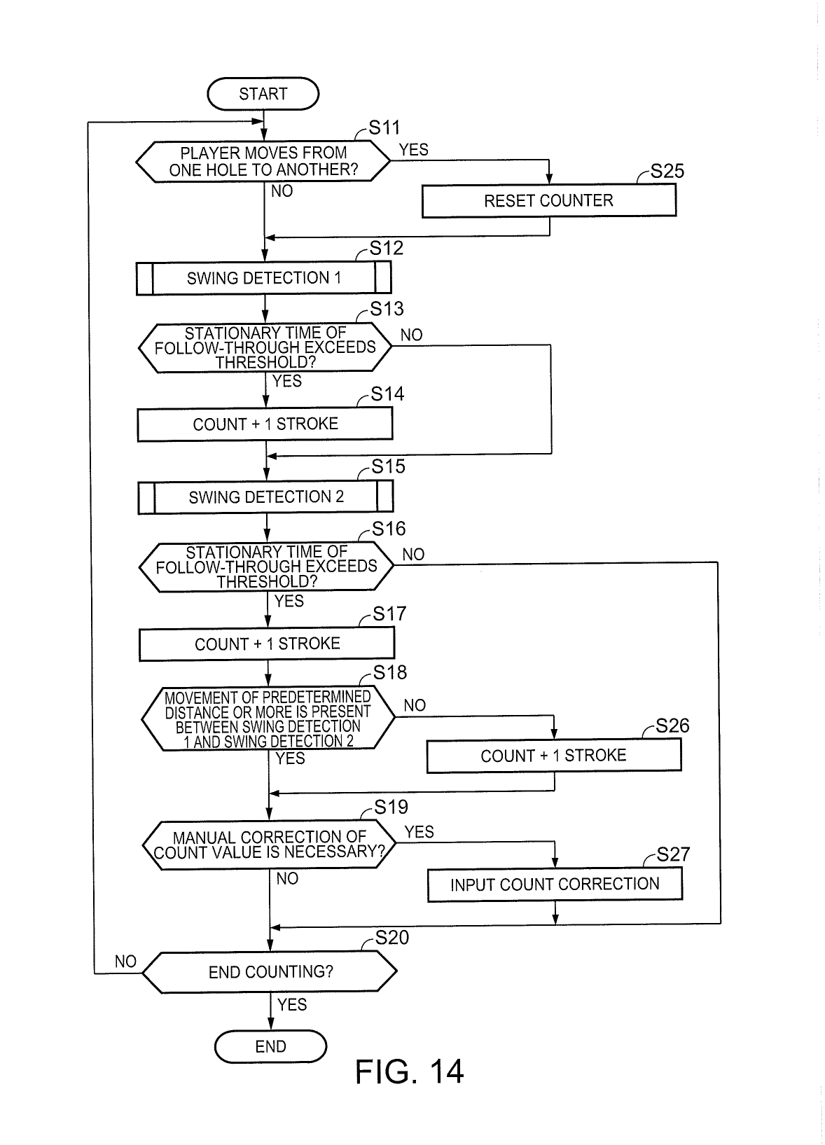

The storing section 730 has stored therein the impact reference data 880 and the swing reference data 870 to be read out by the number-of-strokes counting section 710 and referred to when number-of-strokes count processing is executed and the number-of-strokes calculating program 800 to be read out by the count processing section 720 and used for executing number-of-strokes calculation processing (see FIG. 14).

Besides, the storing section 730 has stored therein hole data 390 serving as reference data, a sensing data table 810, a GPS data table 320, a terrestrial magnetism data table 330, a calculation data table 340, swing basic information 350, and the like.

The swing reference data 870 and the impact reference data 880 are reference data such as thresholds serving as determination criteria in detecting, when the number-of-strokes counting section 710 performs the number-of-strokes count processing, whether a motion of the golf club 90 is a swing and whether there is an impact in the swing of the golf club 90 when a swing of the player and an impact are detected by the swing detecting section 712 and the impact detecting section 714 from outputs of the inertia sensors of the inertia measuring unit 110.

The hole data 390 is map data of holes rounded by the player. By placing positioning data acquired by the GPS unit 750 on the hole data 390, it is possible to grasp the position of the player in the holes and grasp a rough motion of the player.

The number-of-strokes calculating program 800 is used for generating, when the count processing section 720 generates number-of-strokes data of the player, the number-of-strokes data of the player using number-of-strokes count data generated on the basis of outputs of the inertia sensors of the inertia measuring unit 110, sensing data respectively received from the GPS unit 750 and the terrestrial magnetism sensor 60, and other reference data and computer programs stored in the storing section 730.

The sensing data table 810 is a data table that stores, in time series, sensing data (detection results of the inertia measuring unit 110) that the number-of-strokes counting section 710 receives from the inertia measuring unit 110.

The GPS data table 320 is a data table that stores, in time series, GPS data (detection results of the GPS unit (GPS sensor) 750) that the count processing section 720 receives from the GPS unit 750.

The terrestrial magnetism data table 330 is a data table that stores, in time series, terrestrial magnetism data (detection results of the terrestrial magnetism sensor 60) that the count processing section 720 receives from the terrestrial magnetism sensor 60).

The calculation data table 340 is a data table that stores, in time series, velocities, positions, and posture angles that the count processing section 720 calculates using the sensing data.

The swing basic information 350 is information in which information obtained by adding the time information input from the GPS unit 750 to the data concerning the state of the swing of the player and the data concerning the impact output from the swing detecting section 712 and the impact detecting section 714 is stored in time series.

Characteristics of motions (routine motions, etc.) before and after a swing or a swing motion of the player can be recognized from the information stored in time series in the swing basic information 350. Therefore, in the counting of the number of strokes by the counting system 701 referring to the swing basic information 350, it is possible to correct the number of strokes calculated by recognizing individual differences (habits) of each player and eliminate an error in a count value due to the individual differences.

The count processing section 720 is configured by, for example, a CPU (Central Processing Unit), a DSP (Digital Signal Processor), or an ASIC (Application Specific Integrated Circuit). The count processing section 720 performs processing for generating, on the basis of a number-of-strokes count value acquired from the number-of-strokes counting section 710, an accurate number of strokes of the player according to various computer programs stored in the storing section 730. Specifically, the count processing section 720 receives, in the number-of-strokes-count-value acquiring section 721, the number-of-strokes count value counted by the number-of-strokes counting section 710 on the basis of the outputs from the inertia sensors of the inertia measuring unit 110, receives the GPS data and the terrestrial magnetism data respectively from the GPS unit 750 and the terrestrial magnetism sensor 60, and generates, with the number-of-strokes generating section 250, an accurate number of strokes of the player using these data. The count processing section 720 includes, in the number-of-strokes generating section 250, the number-of-strokes adjusting section 255 that performs, according to necessity, adjustment of the number of strokes generated by the number-of-strokes generating section 250. The count processing section 720 transmits the generated number of strokes of the player to the display device 703 via the communication section 40. The display device 703 outputs received number-of-strokes information in a form of text an image, sound, vibration, or the like.

The communication section 40 performs data communication with the communication section 140 of the display device 703. The communication section 40 performs, for example, processing for receiving the number-of-strokes information generated by the count processing section 720 and transmitting the number-of-strokes information to the display device 703 and processing for receiving commands (commands for count start/stop of the number of strokes, commands for start/stop of number-of-strokes adjustment processing, etc.) transmitted from the display device 703 and sending the commands to the count processing section 720.

The display device 703 includes the processing section 120, the storing section 130, the communication section 140, the operation section 150, the clocking section 160, the display section 170, the sound output section 180, and the vibrating section 190. However, in the display device 703 in this embodiment, a part of the components may be deleted or changed or other components may be added.

The processing section 120 performs various kinds of arithmetic processing and control processing according to computer programs stored in the storing section 130. For example, the processing section 120 performs processing for receiving various kinds of processing (commands for count start/stop of the number of strokes, commands for start/end of the number-of-strokes adjustment processing, etc.) information corresponding to operation data received from the operation section 150 and sending text data or image data corresponding to the output information to the display section 170, processing for sending sound data corresponding to the output information to the sound output section 180, and processing for sending vibration data corresponding to the output information to the vibrating section 190. The processing section 120 performs, for example, processing for generating time image data corresponding to time information received from the clocking section 160 and sending the time image data to the display section 170.

The storing section 130 is configured by, for example, various IC memories such as a ROM in which computer programs and data for the processing section 120 to perform various kinds of processing are stored and a RAM functioning as a work region of the processing section 120.

The communication section 140 performs data communication with the communication section 40 of the number-of-strokes calculating device 702. The communication section 140 performs processing for receiving commands (commands for count start/stop of the number of strokes, commands for start/end of the number-of-strokes adjustment processing, etc.) corresponding to operation data from the processing section 120 and sending the commands to the number-of-strokes calculating device 702 and processing for receiving accurate number-of-strokes information of the player transmitted from the number-of-strokes calculating device 702 and sending the accurate number-of-strokes information to the processing section 120.

The operation section 150 performs processing for acquiring operation data (operation data of, for example, count start/stop of the number of storks, input data of number-of-strokes adjustment, and operation data of selection of display content) from the player and sending the operation data to the processing section 120. The operation section 150 may be, for example, a touch panel display, a button, a key, or a microphone.

Note that, in the counting system 701 in this embodiment, the operation section 150 functions as an input section for inputting an adjustment value to the number-of-strokes adjusting section 255 when the operation section 150 performs manual correction of the number of strokes explained below.

The clocking section 160 performs processing for generating time information such as year, month, day, hour, minute, and second. The clocking section 160 is realized by, for example, a real time clock (RTC) IC.

The display section 170 displays image data or text data sent from the processing section 120 as characters, a graph, a table, animation, or other images. The display section 170 is realized by, for example, a display such as an LCD (Liquid Crystal Display), an organic EL (Electroluminescence) display, or an EPD (Electrophoretic Display). The display section 170 may be a touch panel display. Note that the functions of the operation section 150 and the display section 170 may be realized by one touch panel display.

The sound output section 180 outputs, as sound such as voice or buzzer sound, sound data sent from the processing section 120. The sound output section 180 is realized by, for example, a speaker or a buzzer.

The vibrating section 190 vibrates according to vibration data sent from the processing section 120. The vibration is transmitted to the display device 703. The player wearing the display device 703 can feel the vibration. The vibrating section 190 is realized by, for example, a vibration motor.

### II. Number-of-Strokes Counting (Number-of-Strokes Calculating) Method (a Procedure of Processing)

A number-of-strokes counting method (a number-of-strokes calculating method) for counting the number of strokes of the player is explained with reference to the drawings. In this embodiment, a counting method (a number-of-strokes calculating method) in counting the number of strokes in a round in which the player plays, for example, eighteen holes is explained. FIG. 14 is a flowchart for explaining an example of a procedure of a number-of-strokes counting method (number-of-strokes generation processing) performed by the number-of-strokes calculating device 702. The number-of-strokes calculating device 702 executes the number-of-strokes calculating program 800 stored in the storing section 730 to thereby execute number-of-strokes calculation processing in the procedure of the flowchart of FIG. 14. Note that it goes without saying that the invention includes a computer program for executing a counting method explained below using the counting system 701.

In FIG. 14, when receiving a command for a number-of-strokes count start by operation of, for example, the operation section 150 of the display device 703 by the player, the number-of-strokes calculating device 702 starts the number-of-strokes counting method. When the number-of-strokes counting method is started, first, the number-of-strokes calculating device 702 determines, according to the hole data 390 of the storing section 730 and present location information of the player by the GPS unit 750, whether the player moves from one hole to another (step S11).

When it is determined that the player moves from one hole to another (Yes in step S11), the number-of-strokes counting section 710 and the count processing section 720 of the number-of-strokes calculating device 702 reset a counter (step S25). When the player does not move from one hole to another (No in step S11), the number-of-strokes calculating device 702 stays on standby without performing anything until swing detection 1 in step S12.

Note that the determination concerning whether the player moves from one hole to another is an essential step every time the player moves from one hole to another after the player moves to a second hole after finishing a round of a first hole. However, the determination does not have to be implemented in a first hole immediately after the start of a round. In this case, the counter only has to be set to be reset when a command for a number-of-strokes count start is received or only has to be set to zero when the number-of-strokes count is started.

After the counter reset, the swing detecting section 712 of the number-of-strokes counting section 710 acquires sensing data from output of the inertia sensors of the inertia measuring unit 110. When a swing (“a swing 1”) of the golf club 90 of the player is detected by performing an arithmetic operation using the acquired sensing data, GPS data obtained from a detection result of the GPS unit 750, and terrestrial magnetism data obtained from the terrestrial magnetism sensor 60 (step S12), the number-of-strokes-count-value detecting section 716 counts a number-of-strokes count value 1 on the basis of a detection result of the swing. The count value 1 is acquired by the number-of-strokes count-value acquiring section 721 of the count processing section 720 and added to the sensing data table 810 of the storing section 730 in time series.

Subsequently, the count processing section 720 determines whether the count value 1 acquired by the number-of-strokes count-value acquiring section 721 should be counted as the number of strokes of the player. In other words, the count processing section 720 determines whether the swing (“the swing 1”) detected by the swing detecting section 712 in the swing detection 1 of step S12 and counted as the count value 1 is counted as the number of strokes of the player. In this embodiment, whether the count value 1 is counted as the number of strokes is determined according to whether a stationary time of follow-through in the swing of the player detected by the swing detecting section 712 exceeds a threshold. That is, when the “swing 1” is a swing of a “shot” that is counted as the number of strokes, compared with when the “swing 1” is a single of a mere “practice swing”, the stationary time (a holding time) of the follow-through is long. Therefore, a threshold is set for the stationary time of the follow-through of the swing. It is possible to determine that a swing having a stationary time exceeding the threshold is the swing of the “shot” that can be counted as the number of strokes.

Follow-through in a track of a swing can be detected by the inertia sensors of the inertia measuring unit 110 attached to the golf club 90. Time information is added to detection results by the inertia sensors and output. Therefore, the holding time of the follow-through can be learned from the time information added to detection data of the inertia sensors.

When the stationary time of the follow-through is longer than the threshold (Yes in step S13), the count processing section 720 determines that the count value 1 is counted as the number of strokes of the player and counts one stroke (step S14). When the stationary time of the follow-through is shorter than the threshold (No in step S13), the count processing section 720 does not add the number of stokes and proceeds to step S15 in which the next swing is detected.

Subsequently, the swing detecting section 712 performs an arithmetic operation using sensing data acquired from outputs of the inertia sensors of the inertia measuring unit 110, GPS data, and terrestrial magnetism data to detect a swing (“a swing 2”) of the player (step S15). Then, the number-of-strokes-count-value detecting section 716 counts the number-of-strokes count value 1 on the basis of a detection result of the swing 2. The count value 1 is acquired by the number-of-strokes-count-value acquiring section 721 of the count processing section 720 and added to the sensing data table 810 of the storing section 730 in time series.

Subsequently, as in step S13, the count processing section 720 determines whether a stationary time of follow-through in the swing 2 of the player exceeds the threshold to thereby determine whether the swing 2 is a shot that is counted as the number of strokes. When the stationary time of the follow-through is longer than the threshold (Yes in step S16), the count processing section 720 determines that the count value 1 of the swing 2 is counted as the number of strokes of the player and counts one stroke (step S17). When the stationary time of the follow-through is shorter than the threshold (No in step S16), the count processing section 720 proceeds to step S20.

Subsequently, the count processing section 720 determines whether movement included in a given condition range is present between the “swing 1” detected in the swing detection 1 of step S12 and determined as the shot in step S13 and the “swing 2” detected in the swing detection 2 of step S15 and determined as the shot in step S16, specifically, whether the player moves a predetermined distance or more (step S18). When the movement of the predetermined distance or more is present between the swing 1 of the swing detection 1 and the swing 2 of the swing detection 2 (Yes in step S18), the count processing section 720 proceeds to step S19 without changing the count of the number of strokes.

When the movement of the predetermined distance or more is absent between the swing 1 of the swing detection 1 and the swing 2 of the swing detection 2 and the swing 2 is performed in a position substantially the same as the position of the swing 1 (No in step S18), it can be determined that OB (Out of Bounds) occurs in which a golf ball is hit to the outside of a play area by the shot of the swing 1. That is, because the OB occurs, it can be determined that the player hits the ball again in the swing 2 from a point same as the point of the swing 1. When the OB occurs, one penalty stroke is given and one stroke is added. The swing 2, which is hitting of the swing 1 performed again, is a third stroke. Therefore, when the movement of the predetermined distance or more is absent between the swing 1 and the swing 2 (the player hits the ball again substantially in the same position) (No in step S18), the count processing section 720 counts one stroke (step S26) and thereafter proceeds to step S19.

Subsequently, in step S19, the count processing section 720 checks whether manual correction needs to be performed for the number of strokes counted so far. For example, as a routine of the number-of-strokes calculating program 800, timing for determining whether the manual correction needs to be performed is notified to the player by character display, sound, vibration, or the like of the display device 703.

The manual correction needs to be performed when a correct number of strokes is not counted in steps S11 to S18 (step S26), for example, when the player intends to hit a ball but misses hitting the ball in the swing 1 detected in the swing detection 1 of step S12 or the swing 2 detected in the swing detection 2 of step S15 or when the ball moves after address and the player replaces the ball and continues the play.

When the manual correction needs to be performed (Yes in step S19), for example, the count processing section 720 performs a count correction input for adding or subtracting a count value (inputting a count adjustment value) with the operation section 150 of the display device 703 (step S27).

When it is unnecessary to perform the manual correction (No in step S19), the count processing section 720 proceeds to step S20.

Subsequently, in step S20, the count processing section 720 determines whether to end the counting of the number of strokes, that is, end the play. When continuing the play (the number-of-strokes count) (No in step S20), the count processing section 720 returns to step S11. When ending the play (the number-of-strokes count) (Yes in step S20), the count processing section 720 ends a series of the number-of-strokes counting method (the number-of-strokes calculating method).

As explained above, with the counting system 701 and the counting method (the number-of-strokes calculating method) using the counting system 701 according to this embodiment, effects explained below can be obtained.

In this embodiment, the swing detecting section 712 performs the arithmetic operation using the sensing data acquired from the outputs of the inertia sensors of the inertia measuring unit 110, the GPS data obtained from the detection result of the GPS unit 750, and the terrestrial magnetism data obtained from the terrestrial magnetism sensor 60 to thereby detect the swing (“the swing 1”) of the golf club 90 of the player and count the number-of-strokes count value 1. Similarly, the swing detecting section 712 detects the next swing (“the swing 2”) and counts the number-of-strokes count value 2.

The swing detecting section 712 determines whether the player moves the predetermined distance or more between the swing 1 and the swing 2 and, when the movement of the predetermined distance or more is absent, adjusts the number of strokes with the number-of-strokes adjusting section 255. As a specific example of the adjustment of the number of strokes, when the swing 2 is performed in a position substantially the same as the position of the swing 1, for example, the swing detecting section 712 determines that OB occurs in which a golf ball is hit to the outside of a play area by the shot of the swing 1, determines that the player hits the ball again in the swing 2 from a point same as the point of the swing 1, and adds one penalty stroke of the OB to the number of strokes.

According to this embodiment, it is possible to provide the counting system 701 capable of performing accurate counting on the basis of swing detection results detected by the inertia sensors and GPS data including positioning data at time corresponding to the swing detection result without performing operation such as an input of a count value.

According to this embodiment, the count processing section 720 checks whether the holding time of the follow-through in the track of the swing of the player exceeds the threshold. When the holding time exceeds the threshold, the count processing section 720 determines that the swing is the “shot” counted as the number of strokes. When the holding time is smaller than the threshold, the count processing section 720 determines that the swing is the “practice swing” not counted as the number of strokes.

Consequently, it is possible to contribute to counting of an accurate number of strokes.

The counting system 701 in this embodiment includes the display device 703 functioning as the display terminal including, for example, the display section 170 that displays a counting result and the like.

Consequently, it is possible to perform a play while checking, on a real-time basis, a counting result of the number of strokes by the counting system 701.

The display device 703 includes the operation section 150 functioning as the input section for inputting an adjustment value of the number of strokes of the number-of-strokes adjusting section 255 of the number-of-strokes calculating device 702.

In this embodiment, the counting method includes step S19 for checking whether the manual correction needs to be performed for the counted number of strokes. When the manual correction needs to be performed, the count correction input (the input of the count adjustment value) for adding or subtracting a count value is performed.

Consequently, in the counting system 701 in this embodiment that adjusts a count value of the number of strokes when the position of the player at time corresponding to a detection result of the swing detection 1 and the position of the player at time corresponding to a detection result of the swing detection 2 are in a given relation, an adjustment value can be input by a manual input when an unexpected situation occurs in the given relation. Therefore, it is possible to provide the counting system 701 capable of obtaining a counting result of an accurate number of strokes even when the unexpected situation occurs.

### Sixth Embodiment

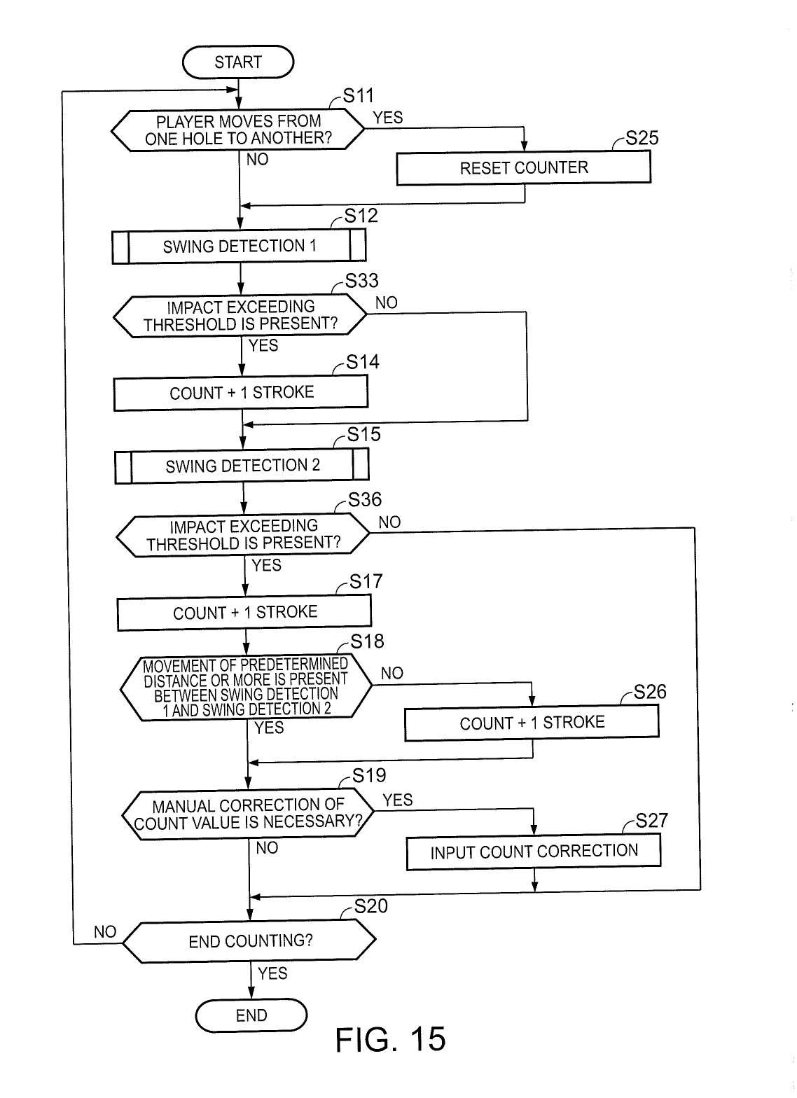

A counting method for the number of strokes of a player according to a sixth embodiment is explained with reference to the diagrams. FIG. 15 is a flowchart for explaining a procedure of the counting method for the number of strokes (a number-of-strokes calculating method) according to the sixth embodiment. Note that, as in the fifth embodiment, the counting method using the counting system 701 shown in FIGS. 12 and 13 is explained. In the following explanation, components same as the components in the fifth embodiment are denoted by the same reference numerals and signs and redundant explanation of the components is omitted.

The counting method for the number of strokes in the sixth embodiment shown in FIG. 15 is the same as the counting method for the number of strokes in the fifth embodiment shown in FIG. 14 except a determining method for determining possibility of number-of-strokes count of the swing 1 performed after the swing detection 1 in step S12 (step S33) and a determining method for determining possibility of number-of-strokes count of the swing 2 performed after the swing detection 2 in step S15 (step S36). Therefore, only the determining methods for determining possibility of number-of-strokes count of the swings in steps S33 and S36 are explained.

In step S12 shown in FIG. 15, the swing detecting section 712 of the number-of-strokes counting section 710 performs an arithmetic operation using sensing data acquired from outputs of the inertia sensors of the inertia measuring unit 110, GPS data, and terrestrial magnetism data to thereby detect a swing (“the swing 1”) of the player. Then, the number-of-strokes count value 1 is counted. Subsequently, the count processing section 720 determines whether the count value 1 should be counted as the number of strokes of the player. In this embodiment, whether the count value 1 is counted as the number of strokes is determined according to whether an impact exceeding a threshold is present in a swing of the player detected by the swing detecting section 712. That is, when the “swing 1” is a swing of a “shot” counted as the number of strokes, a predetermined impact is detected at predetermined timing during a swing of the golf club 90. On the other hand, when the “swing 1” is a swing of a mere “practice swing”, an impact is hardly present or is extremely small (e.g., a peak of wind pressure applied to the club face or the shaft 92 of the golf club 90). Therefore, by detecting an impact equal to or larger than the threshold detected at the predetermined timing during the swing, it is possible to clearly determine that the swing is the swing of the “shot” that can be counted as the number of strokes.

The impact during the swing can be detected by the inertia sensors of the inertia measuring unit 110 attached to the golf club 90. Timing of the impact during the swing can be learned from time information added to detection data of the inertia sensors.

When an impact exceeding the threshold is detected during the swing (Yes in step S33), the count processing section 720 determines that the count value 1 is counted as the number of strokes of the player and counts one stroke (step S14). When the impact during the swing of the swing 1 is smaller than the threshold or absent (No in step S33), the count processing section 720 does not perform addition of the number of strokes and proceeds to step S15 in which the next swing is detected.

With the same method, according to whether an impact exceeding the threshold is present during a swing of the “swing 2”, it is possible to determine whether the “swing 2” is the swing of the “shot” counted as the number of strokes. When the impact exceeding the threshold is detected during the swing of the swing 2 (Yes in step S36), the count processing section 720 determines that the count value is counted as the number of strokes of the player and counts one stroke (step S17). When the impact during the swing of the swing 2 is smaller than the threshold or absent (No in step S36), the count processing section 720 proceeds to step S20.

Note that a plurality of the thresholds of the impact set in the impact detection explained above may be set according to necessity. For example, an impact detected when the swing is a practice swing is hardly present or extremely small. Therefore, a threshold of the impact of the practice swing is set. When the impact is smaller than the threshold, the swing can be determined as the practice swing. Similarly, between the threshold of the impact of the “shot” and the threshold of the impact of the “practice swing”, a threshold of an impact of an “approach shot” weaker than the impact of the “shot”, a threshold of an impact of a “putter” still weaker than the threshold of the impact of the “approach shot”, and the like are included in the impact reference data 880 of the storing section 730. Consequently, it is possible to specify a type of a shot from an impact detection result by the impact detecting section 714 and store the type of the shot.

As explained above, with the counting method for the number of strokes in the sixth embodiment, when an impact exceeding the threshold is detected during a swing, a count value of the swing is determined as the number of strokes of the player and one stroke is counted. When an impact during the swing is smaller than the threshold or absent, the swing is determined as a swing not counted as the number of strokes.

With this configuration, it is possible to exclude a swing not being a target of counting such as a practice swing and perform counting of an accurate number of strokes.

The embodiments of the invention devised by the inventor are specifically explained above. However, the invention is not limited to the embodiments explained above. Various changes can be added to the embodiments without departing from the spirit of the invention.

For example, in the first embodiment, the counting of the number of strokes in the round of the golf is explained in detail. However, the invention is not limited to this. For example, in a golf competition, which is not an official round, a putter golf, or a hitting practice performed in a golf practice range, it is possible to apply the form analyzing system 1 and the form analyzing method in the embodiments and attain improvement of a form of a swing.

In the first embodiment, the example is explained in which, for example, the form analysis processing for a swing in performing a shot such as a tee shot is implemented. The invention is not limited to this. It is also possible to adopt a method of use for performing form analysis processing for a swing of a practice swing before the shot, perform improvement of a form referring to an advice of the notifying section 50, and perform an actual shot after confirming that the form is in a good state.

The form analyzing system 1 including the form analyzing device 2, the form analyzing method using the form analyzing system 1, and the form analyzing program 17 for causing the form analyzing system 1 to execute the form analyzing method are not limited to the application to the golf swing. The form analyzing system 1, the form analyzing method, and the form analyzing program 17 can also be applied to other sports in which a swing by a hitting instrument held by the upper limb or the hand is performed. The invention can be applied to, for example, a swing by a hitting instrument held by the hand such as a bat or a racket in baseball, softball, badminton, table tennis, hockey, gate ball, mallet golf, and the like and a swing of the upper limb such as spike of volleyball.

As the display section 170 of the notifying section 50, a head mount display (HMD) or a so-called smart contact in which a display device is incorporated in a contact lens may be used to cause the display devices to display the present form information.

In the second embodiment, the first detecting device 602A of the putting detecting systems 601, 601A, 601B, and 601C is incorporated in the wrist instrument 603 together with the inertia measuring unit 110 and the display device 650. The invention is not limited to this. The first detecting device 602A and the wrist instrument 603 may be separated and, for example, communication sections may be provided in both of the first detecting device 602A and the wrist instrument 603 to perform data communication.

In the second embodiment, the putting detection result by the second detecting device and the swing detection result by the first detecting device can be notified by the wrist instrument 603, the display device 650, or the other communication unit such as sound or vibration.

The invention is not limited to this. The putting detecting system 601 and an external device such as a portable communication device like a smart phone or a personal computer may be paired to notify the player of a detection result of detection by the putting detecting system 601 via the external device.

The external device may be used as the switching unit 621 and the operation section 440.

In the fifth embodiment, the counting of the number of strokes in the round of the golf is explained in detail. However, the invention is not limited to this. For example, the counting system 701 and the counting method in the embodiment can also be applied to, for example, a golf competition, which is not an official round, and a putter golf.

The counting system and the counting method of the invention are not limited to the application to the golf. The counting system and the counting method can also be applied to other sports and the like in which counting of hitting by a hitting instrument is performed. For example, the counting system and the counting method can be used in counting of times at bat of a hitting practice of baseball.

In the fifth embodiment, the time information from the GPS unit 750 added to the data concerning the state of the swing and the data concerning the impact output from the swing detecting section 712 and the impact detecting section 714 is not always the same as detection time of the impact. The time information may deviate from the detection time of the impact as long as the time information is within a period of the same swing.

In the fifth embodiment, the number-of-strokes information is displayed on the display device 703 of the player. However, the number-of-strokes information may be transmitted to a score managing device and used for management and recording of a score. The score managing device may be an independent device or may be integrated with at least one of the number-of-strokes calculating device 702 and the display device 703.

In the fifth embodiment, the GPS unit 750 is used as the positioning device that measures the position of the player. However, the invention is not limited to this.

For example, the counting system can also be configured using a so-called beacon that receives, with a receiver, a radio wave and an electromagnetic wave emitted from a radio station or the like set in a golf course and performs positioning or other positioning systems that make use of short-range communication or the like.

In the fifth embodiment, it is checked whether the holding time of the follow-through in the track of the swing of the player exceeds the threshold. When the holding time exceeds the threshold, it is determined that the swing is the “shot” counted as the number of strokes. In the sixth embodiment, when the impact exceeding the threshold is detected during the swing, the count value of the swing is determined as the number of strokes of the player and one stroke is counted. The invention includes a configuration in which, when the holding time of the follow-through exceeds the threshold and the impact exceeding the threshold is detected during the swing, the count value of the swing is determined as the number of strokes of the player and one stroke is counted.

What is claimed is:

1. A form analyzing device comprising:
a storing section configured to store form information in past in which detection results in the past of a physical quantity sensor attached to an upper limb of a user or a hitting instrument held by a hand of the user and forms of swings of the user are associated;
an estimating section configured to extract, from the storing section, the form information in the past corresponding to a present detection result of the physical quantity sensor; and
a notifying section configured to notify the user of present form information based on the form information in the past corresponding to the present detection result.

2. The form analyzing device according to claim 1, wherein the form analyzing device further includes the physical quantity sensor.

3. The form analyzing device according to claim 1, further comprising a communication section configured to communicate with the physical quantity sensor.

4. The form analyzing device according to claim 1, wherein the present form information includes an advice for improving a form.

5. The form analyzing device according to claim 1, wherein the present form information includes images of the forms.

6. A form analyzing system comprising:
a physical quantity sensor attached to an upper limb of a user or a hitting instrument held by a hand of the user; and
a form analyzing device including:
a communication section configured to communicate with the physical quantity sensor;
a storing section configured to store form information in past in which detection results in the past of a physical quantity sensor and forms of swings of the user are associated;
an estimating section configured to extract, from the storing section, the form information in the past corresponding to a present detection result of the physical quantity sensor; and
a notifying section configured to notify the user of present form information based on the form information in the past corresponding to the present detection result.

7. A form analyzing method comprising:
storing, in a storing section, form information in past in which detection results in the past of a physical quantity sensor attached to an upper limb of a user or a hitting instrument held by a hand of the user and forms of swings of the user are associated;
extracting, from the storing section, the form information in the past corresponding to a present detection result of the physical quantity sensor; and
notifying the user of present form information based on the form information in the past corresponding to the present detection result.

8. The form analyzing method according to claim 7, wherein the present form information includes an advice for improving a form.

9. The form analyzing method according to claim 7, wherein the present form information includes images of the forms.

10. A form analyzing program for causing a form analyzing system to execute a form analyzing method comprising:
storing, in a storing section, form information in past in which detection results in the past of a physical quantity sensor attached to an upper limb of a user or a hitting instrument held by a hand of the user and forms of swings of the user are associated;
extracting, from the storing section, the form information in the past corresponding to present detection result of the physical quantity sensor; and
notifying the user of present form information based on the form information in the past corresponding to the present detection result.
